(19) United States
(12) Patent Application Publication
(10) Pub. No.: US 2023/0192977 A1
(43) Pub. Date: Jun. 22, 2023

(54) DYNAMIC FIELD CONDITIONING OF POLYMER NANO-STRUCTURE

(71) Applicant: The Government of the United States of America, as represented by the Secretary of the Navy, Arlington, VA (US)

(72) Inventor: Aleta T. Wilder, Leander, TX (US)

(73) Assignee: The Government of the United States of America, as represented by the Secretary of the Navy, Arlington, VA (US)

(21) Appl. No.: 18/066,047

(22) Filed: Dec. 14, 2022

Related U.S. Application Data
(60) Provisional application No. 63/290,753, filed on Dec. 17, 2021.

(51) Int. Cl. C08J 5/22; C08J 5/08

(52) U.S. Cl. CPC C08J 5/2256; C08J 5/08; C08J 2300/104; C08J 2300/24

(57) ABSTRACT

A method of: providing a polymeric material, and inducing optical or acoustic phonons into the material. The inducing is performed by application of an alternating electric field or a dynamic mechanical field. When the method is performed on a polyepoxy thermoset, this may result in a water absorption rate of no more than 0.1 wt. % per 24 hours.

This application claims the benefit of U.S. Provisional Application No. 63/290,753, filed on Dec. 17, 2021. The provisional application and all other publications and patent documents referred to throughout this nonprovisional application are incorporated herein by reference.

### TECHNICAL FIELD

The present disclosure is generally related to conditioning of polymers.

### DESCRIPTION OF RELATED ART

Characterization of aging for insulation in the power-dense electrical machinery environment is increasingly important. This environment is moving towards higher temperature excursions, higher applied voltages, significantly higher power switching frequencies, and more rapid variation in the environment during machine operation. Insulation in the power-dense machine environment encounters thermal expansion stresses, core dimensional distortions, high frequency vibrations from the drive, and Lorentz forces (Fuentes, “Various applications of discontinuous Petrov-Galerkin (DPG) finite element methods.” Doctoral Dissertation, The University of Texas at Austin, (2018)). The magnetic core and conductive coil materials are much stiffer than polymeric insulation. The ability to respond to cyclic mechanical stress without cracking or delamination is desirable. Often the polymeric matrix material provides an elasticity to the machine environment as well as voltage stand-off.

### BRIEF SUMMARY

Disclosed herein is a method comprising: providing a polymeric material and inducing optical or acoustic phonons into the material. The inducing is performed by application of an alternating electric field or a dynamic mechanical field.

Also disclosed herein is a composition comprising a polyepoxy thermoset, wherein the composition has a water absorption rate of no more than 0.1 wt. % per 24 hours.

### BRIEF DESCRIPTION OF THE DRAWINGS

A more complete appreciation will be readily obtained by reference to the following Description of the Example Embodiments and the accompanying drawings.

FIG. 1 shows real permittivity vs. frequency for Permafil 74050 with mechanical aging.

FIG. 2 shows imaginary permittivity vs. frequency for Permafil 74050 with mechanical aging.

FIG. 3 shows dynamic storage modulus vs. temperature for Permafil 74050 with mechanical aging.

FIG. 4 shows dynamic loss modulus vs. temperature for Permafil 74050 with mechanical aging.

FIG. 5 shows real permittivity vs. frequency for Permafil 74050 with electrical aging.

FIG. 6 shows imaginary permittivity vs. frequency for Permafil 74050 with electrical aging.

FIG. 7 shows dynamic storage modulus vs. temperature for Permafil 74050 with electrical aging.

FIG. 8 shows dynamic loss modulus vs. temperature for Permafil 74050 with electrical aging.

FIG. 9 shows real permittivity vs. frequency for Fr5 with mechanical aging.

FIG. 10 shows imaginary permittivity vs. frequency for Fr5 with mechanical aging.

FIG. 11 shows dynamic storage modulus vs. temperature for Fr5 with mechanical aging.

FIG. 12 shows dynamic loss modulus vs. temperature for Fr5 with mechanical aging.

FIG. 13 shows real permittivity vs. frequency for Fr5 with electrical aging.

FIG. 14 shows imaginary permittivity vs. frequency for Fr5 with electrical aging.

FIG. 15 shows dynamic storage modulus vs. temperature for Fr5 with electrical aging.

FIG. 16 shows dynamic loss modulus vs. temperature for Fr5 with electrical aging.

FIG. 17 shows dielectric storage modulus for epoxy with aging treatment.

FIG. 18 shows dielectric loss modulus for epoxy with aging treatment.

FIG. 19 shows mechanical storage modulus for epoxy with aging treatment.

FIG. 20 shows mechanical loss modulus for epoxy with aging treatment.

FIG. 21 shows dielectric storage modulus for epoxy laminate with aging treatment.

FIG. 22 shows dielectric loss modulus for epoxy laminate with aging treatment.

FIG. 23 shows mechanical storage modulus for epoxy laminate with aging treatment.

FIG. 24 shows mechanical loss modulus for epoxy laminate with aging treatment.

FIG. 25 shows mechanical and dielectric real moduli vs. temperature at 1 Hz for epoxy.

FIG. 26 shows mechanical and dielectric imaginary moduli vs. temperature at 1 Hz for epoxy.

FIG. 27 shows real permittivity (top) and imaginary permittivity (bottom) vs. frequency for Pn0 aged by heat-treating (Pn0-HT), electrically aging (Pn0-ERT), and an added second electrical aging (Pn0-ERT2).

FIG. 28 shows real electric modulus (top) and imaginary electric modulus (bottom) at 30° C. for Pt0 (nano-silica modified epoxy) and Pn0 (neat epoxy), with mechanical aging as noted.

FIG. 29 shows real electric modulus (top) and imaginary electric modulus (bottom) at 150° C. for Pt0 (nano-silica modified epoxy) and Pn0 (neat epoxy), with mechanical aging as noted.

FIG. 30 shows real permittivity for Pm0 (mica-filled epoxy) after treatments, measured at 50° C. or 150° C.

FIG. 31 shows imaginary permittivity for Pm0 (1 wt. % mica-filled epoxy) after treatments, measured at 50° C. or 150° C.

FIG. 32 shows real permittivity (top) and imaginary permittivity (bottom) for ME-HT (high mica-epoxy after heat treatment), and ME-HT+ERT (after heat treatment and electrical aging).

FIG. 33 shows real permittivity (top) and imaginary permittivity (bottom) for MS-HT (high mica-silicone after heat treatment), and MS-HT+ERT (after heat treatment and electrical aging).

FIG. 34 shows real permittivity (top) and imaginary permittivity (bottom) for Fr5 laminate before and after electrical aging.

FIG. 35 shows real permittivity (top) and imaginary permittivity (bottom) for Fr5 laminate before and after mechanical aging.

FIG. 36 shows real permittivity (top) and imaginary permittivity (bottom) for G7 laminate before and after electrical aging.

FIG. 37 shows real permittivity (top) and imaginary permittivity (bottom) for G7 laminate before and after mechanical aging.

FIG. 38 shows real permittivity (top) and imaginary permittivity (bottom) for G7 laminate before and after mechanical aging at room temperature with shading added.

FIG. 39 shows real modulus (top) and imaginary modulus (bottom) for neat epoxy Pn0 before and after aging treatments.

FIG. 40 shows real modulus (top) and imaginary modulus (bottom) for Fr5 laminate before and after aging treatments.

FIG. 41 shows real modulus (top) and imaginary modulus (bottom) for neat silicone Sn0 before and after aging treatments.

FIG. 42 shows real modulus (top) and imaginary modulus (bottom) for G7 laminate before and after aging treatments.

FIG. 43 shows real permittivity (top) and imaginary permittivity (bottom) for Calmicaglas (C0-HT) and after dynamic electric aging treatment at room temperature (C0-HT+ERT, C0-HT+MRT).

FIG. 44 shows imaginary permittivity for Calmicaglas (C0-HT+ERT) after dynamic electrical aging treatment at room temperature.

FIG. 45 shows imaginary permittivity at 50° C. for Calmicaglas (C0-HT), epoxy-fiberglass (FR5-HT), and epoxy-90% mica (ME-HT) after heat treatment, only (top) and after thermal treatment and/or dynamic electrical aging treatment (bottom).

FIG. 46 shows imaginary permittivity at 150° C. for Calmicaglas (C0-HT), epoxy-fiberglass (FR5-HT), and epoxy-90% mica (ME-HT) after heat treatment, only (top) and after thermal treatment and/or dynamic electrical aging treatment (bottom).

FIG. 47 shows dynamic elastic real modulus (top) and dynamic elastic loss modulus (bottom) for Calmicaglas after aging treatments.

FIG. 48 shows imaginary electric moduli vs. frequency for Fr5-ERT (electrically aged at room temperature) shown for six temperatures.

FIG. 49 shows frequency of peak imaginary electric moduli, M″, divided by temperature vs. reciprocal temperature for Fr5 shown for six aging conditions (as listed in Table 5).

FIG. 50 shows a Cole-Cole plot of the imaginary electric modulus, M″ vs. the real electric modulus, M′ for four aging conditions as measured at 127° C.

FIG. 51 shows MWS-relaxation of 90% mica-epoxy PMC, ME-HT+ERT.

FIG. 52 shows peak frequency of the B-relaxation mode for four epoxy materials as a function of reciprocal temperature.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is the use of dynamic fields to treat cured polymer materials to condition the nanostructure to promote cooperative molecular dynamics. The conditioning can causes three main types of nanostructural modifications:
1) Adapting local environments of polar groups to their dipole motions.
2) Reducing exceptional density fluctuations (e.g., healing nanovoids remaining from stresses induced during curing).
3) Producing nano-phase separation.

These three nano-structural modifications are distinctly different from modifications due to thermal annealing or physical aging. (As used herein, “aging” may refer to a process of exposing materials to an environment for an interval of time, whether beneficial or detrimental.) Atomic motion during treatment is on the order of a nanometer or less. Cooperative (“network”) molecular dynamics, as found particularly in thermosets, are sensitive to the conditioning.

Dynamic fields can be applied directly to the polymer by inserting optical phonons, acoustic phonons, or a mixture. The phonon frequencies may range from ˜1 Hz to 1 GHz. This is the spectrum over which molecular dynamics occurs. In practice, treatments have concentrated on application of electric fields ranging from 50 Hz to 500,000 Hz and acoustic/ultrasound ranging from 4000 Hz to 45,000 Hz. The optimal temperature of treatment is dependent on the polymer. Treatments have succeeded both at the glass transition temperature and at over 100° C. less than the glass transition temperature (i.e., below room temperature).

The majority of the conditioning can be achieved relatively quickly. For example, application of an alternating electric field of 0.5 MV/m at 500 kHz for 1 hour completed conditioning of an epoxy as tracked by dielectric thermal analysis (DETA). It is anticipated that applying a range of frequencies or modulating frequencies to generate activity through the polymer's molecular dynamic spectrum may be more efficient.

Promoting a nanostructure that assuages cooperative molecular dynamics improves specific polymer properties. Nano-phase separation can dramatically improve polymer toughness (i.e., resistance to crack growth). The reduction of nanovoids also improves the crack initiation stress and the partial discharge initiation voltage. This improvement to partial discharge initiation voltage likewise enhances voltage endurance. It is anticipated that breakdown strength will similarly improve. Such property improvements are in demand for polymers used in applications as disparate as separation membranes and electrical insulation. The treatment has been shown successful in conditioning polymers that are a composite matrix. It is anticipated that the conditioning could improve toughness in carbon fiber epoxy composites with no negative impact.

The methods disclosed herein may improve several material properties. Nano-phase separation increases the toughness of the polymer. In addition, the method can increase density by reducing nanovoids and ease dielectric relaxation processes by reducing its dielectric strength. Improvements in additional material properties beyond toughness are anticipated.

As an example, all three (increased toughness, increased density, and reduced dielectric strength) can combine to improve breakdown strength and voltage endurance. Improving the latter two behaviors is beneficial to polymers used in electrical insulation. Insulation in electric components is exposed to higher switching frequencies due to many advances in power electronics and control methods. Increase in power density in electrical components is desirable as more power can be transferred in smaller and more portable packages. Both higher frequencies and higher power density place more stress on the electrical insulation. Insulation breakdown and voltage endurance are limiting design factors. They also can precipitate catastrophic destruction of electric components. Improvement of these two properties is desirable.

Application of the dynamic field treatment method as described herein has permitted improved material properties to be obtained beyond insulation breakdown strength. The improvements, due to the dynamic field treatment, are not achieved by thermal processing alone. For example, water absorption was decreased by 50% over an “as received” epoxy composite (Garolite™ G11) and more than 80% as compared to the composite that had been thermally aged. The lower water absorption and increased density both decrease the surface reactivity. This correlates with improved biocompatibility by the dynamic field treatment. In practice this has been observed in a commercial marine epoxy paint demonstrating reduced biofouling after dynamic field treatment (as compared with specified curing, only).

In the methods disclosed herein, a polymeric material undergoes an aging process. Suitable polymeric materials include, but are not limited to, polyimide, polytetrafluoroethylene (PTFE), polyetheretherketone (PEEK), polyepoxy, polyester, and silicon-based polymer. Polymeric material may be a composite that includes the polymer.

The process involves inducing either optical phonons, acoustic phonons, or both in the material. The phonons may be induced, for example, for at least one hour. The frequency of the induced phonons may range, for example, from 1 Hz to 1 GHz.

The induced phonons may have certain beneficial effects. For example, the method may produce nano-phase separation in the polymer, increase the density of the polymer, or increase the voltage breakdown strength of the polymer. In the case of polyepoxy thermoset, the method may form a composition that has a water absorption rate of no more than 0.1 wt. % per 24 hours.

Optical phonons may be induced by application of an alternating electric field to the polymer. This is also referred to as electrical aging. The electrical field may have a frequency of, for example, 50 to 50,000 Hz. The frequency may also be varied over time. The field strength of the electric field may range, for example, from 0.1 to 1 MV/m.

Acoustic phonons may be induced by application of ultrasonic waves or other dynamic mechanical fields or pressure waves. This is also referred to as mechanical aging. The ultrasonic waves may have a frequency of, for example, 4000 to 45,000 Hz. The frequency may also be varied over time.

Four dielectric materials chosen for aging studies are listed in Table 1. All four are rated to at least class H (maximum use temperature of 180° C.) by their manufacturers. Although the matrix materials are not identical (i.e., the epoxy in Fr5 is not Permafil 74050), the comparison of aging behaviors of neat materials with related composite materials is of interest, particularly in relationship to many published studies with micro-composites and nano-composites. The information gathered for the micro-composite materials will be useful as nano-composite aging is studied. (Graphs for silicone materials and all thermal aging not shown, but may be seen in U.S. Provisional Appl. No. 63/290,753.)

TABLE 1
Commercial materials examined with aging treatments

| Commercial designation | Type | Form |
|---|---|---|
| Permafil 74050 (von Roll) | Epoxy | Cured resin |
| Silres H62c (Wacker) | Silicone | Cured resin |
| Fr5 (Accurate Plastics) | Epoxy & woven fiberglass | Laminate composite board |
| G7 (Accurate Plastics) | Silicone & Woven Fiberglass | Laminate composite board |

Samples were prepared to dimension prior to aging by machining and dry polishing with SiC paper (600 grit or finer). Thermal aging was carried out in a temperature-controlled oven in an air atmosphere. All thermal aging consisted heat treatment of 100 hours at 155° C. with a cooling rate of <1° C./min.

Application of mechanical aging was achieved using an oscillating pressure from a wound electric actuator transmitted by direct contact through a fused silica column to the cross-section of each sample. A thin layer of silicone grease was applied to each side of the sample to facilitate wave transmission. The sample rested on a copper block with a thermocouple within 1 cm of the sample. An Agilent waveform generator produced the 9 KHz sine waveform and a Kepco Bipolar 36-120L amplifier produced the power to drive the actuator (Vpk=4.2 V, I=0.94 A). The signal was applied continuously for 1 hour, at either room temperature or the glass transition temperature. The glass transition temperature at 9 kHz was determined from DMA measurements on unaged samples (Insulation integrity for power dense, medium voltage, electric machinery. Final Technical Report, submitted 17 Aug. 2018: Office of Naval Research N00014-15-1-2496).

Application of electrical aging was achieved using an oscillating voltage from a fixed-frequency power supply transmitted with the sample in a parallel plate configuration between two circular copper electrodes. The specially machined copper electrodes were 1.0 inch in diameter and connected to Litz wire leads. The parallel plate arrangement rested on a fused silica tube containing the lead with a thermocouple within 1 cm of the sample. An AspenLabs Inc. MF360A Electrosurgical RF power supply produced the 500 kHz sine waveform with a peak field of 0.3 kV/mm. Voltage and current were monitored using a Tektronix oscilloscope. The signal was applied for 1 hour (alternating 30 s on and 30 s off), at either room temperature or the glass transition temperature. The glass transition temperature at 500 kHz was determined using a standard temperature-time transformation from DMA measurements on unaged samples (Insulation integrity for power dense, medium voltage, electric machinery. Final Technical Report, submitted 17 Aug. 2018: Office of Naval Research N00014-15-1-2496).

Samples were characterized by Dynamic Mechanical Analysis (DMA) and Dielectric Thermal Analysis (DETA). All DMA thermal ramping measurements used 1 Hz. Procedures for these characterizations have been previously described (Insulation aging behaviors characterized with Dielectric Thermal Analysis (DETA). Technical Report 1, submitted 7 Jun. 2019: Office of Naval Research N00014-18-1-2586). For ease of discussion, only DETA spectra at 50° C. and 150° C. are shown in the following graphs, although spectra at 30° C., 75° C., 100° C., and 125° C. were also collected and examined.

Epoxy (Permafil 74050)—Thermal aging of the epoxy resulted in a slight decrease in loss permittivity at low frequency. A shift of the relaxation spectrum to lower frequency is suggested with thermal aging. The real permittivity increased significantly across the frequency spectrum for all temperatures. The DMA graphs show that thermal aging reduced stiffness and increased the dominant glass transition temperature. Although relaxation near the original glass transition temperature range (˜80° C.) may still be observed after thermal aging, a new relaxation (near 140° C.) is shown. This suggests phase separation during thermal aging.

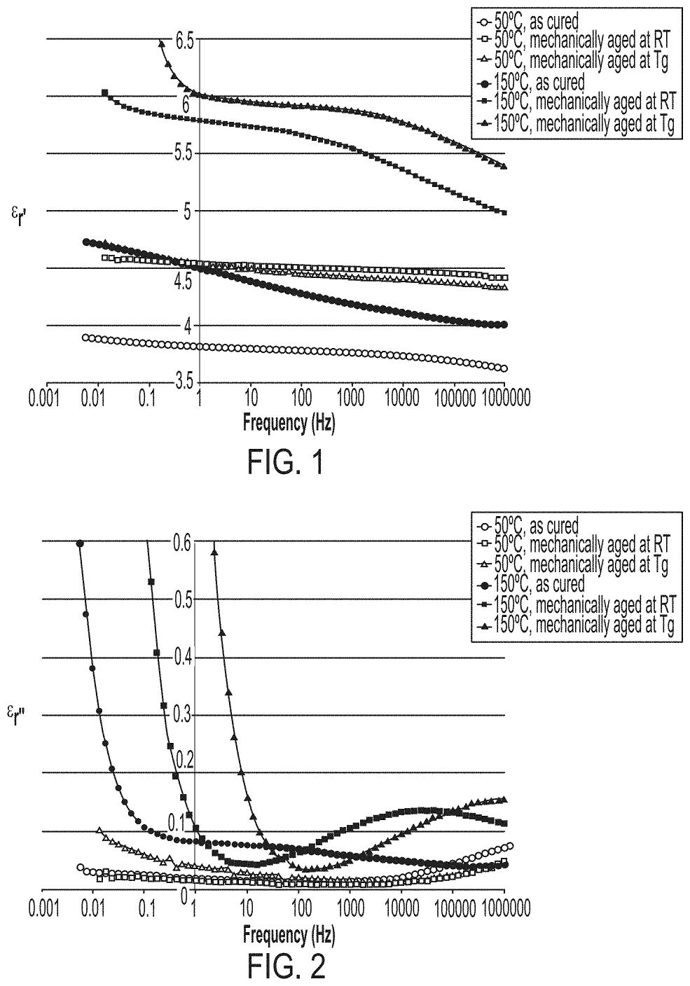

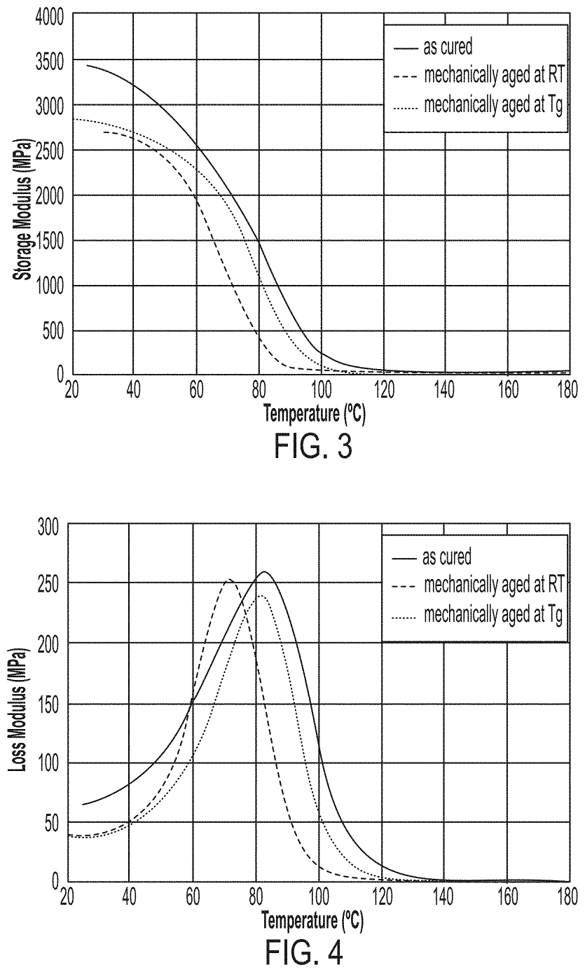

Mechanical aging (FIGS. 1-4) caused an increase in loss permittivity at lower frequencies. This increase was more pronounced for epoxy when mechanically aged at the T_{g}. The difference is also much more pronounced at 150° C. than at 50° C. (FIG. 2). These changes suggest a shift of the relaxation spectra to higher frequencies. The real permittivity of mechanically aged epoxy increased across the spectrum. At 150° C., the real permittivity of the epoxy mechanically aged at the T_{g} shows more change from the as cured epoxy. Graphs of mechanical storage modulus for epoxy subjected to mechanical aging show a reduction in stiffness. The loss of stiffness decreases more rapidly with temperature when mechanically aged at room temperature as compared with material aged at the glass transition (FIG. 3). The mechanical loss modulus shows a small decrease in intensity with mechanical aging (FIG. 4). The relaxation band shifts (−11° C.) to lower temperature with mechanical aging at room temperature and (−1° C.) with mechanical aging at the glass transition.

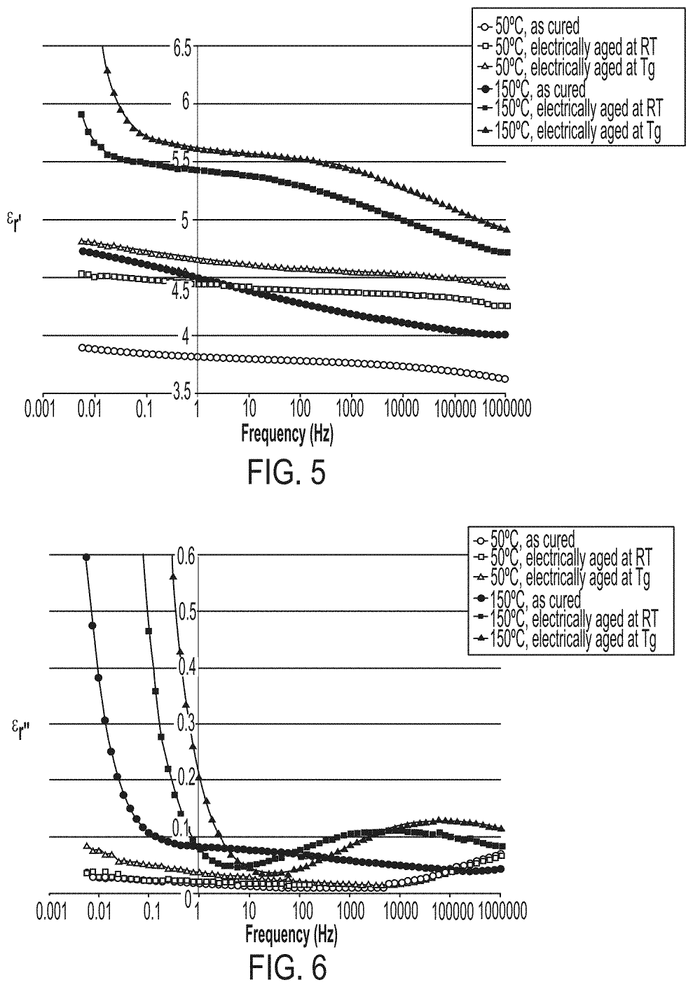

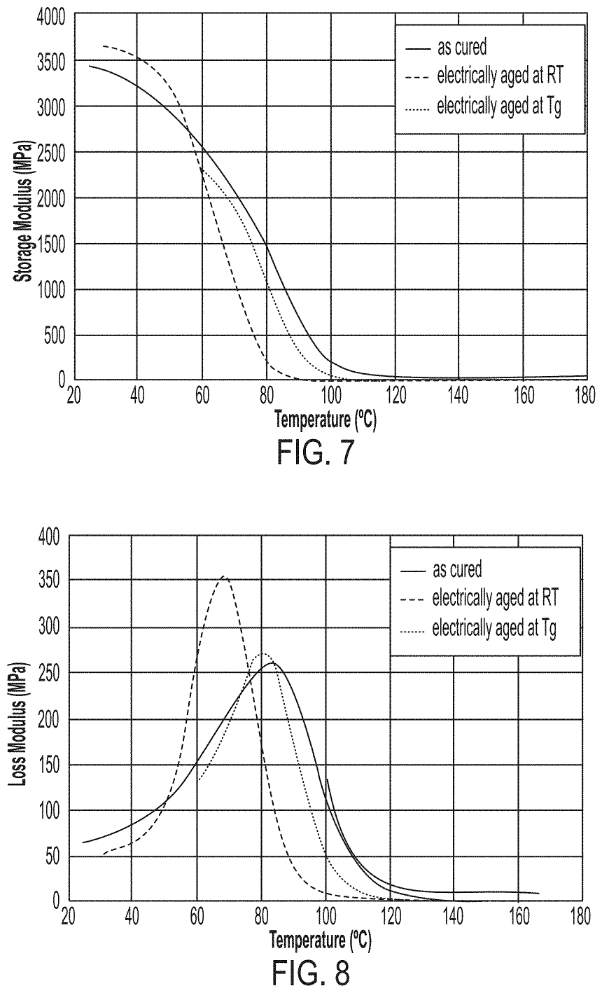

The changes in the epoxy behaviors after electrical aging follow the same trends as those of mechanical aging (FIGS. 5-8). Electrical aging near the glass transition caused more dramatic changes. The dynamic loss relaxation band shifts (−14° C.) to lower temperature with electrical aging at room temperature and (−3° C.) with electrical aging at the glass transition.

Silicone (Silres H62c)—The real permittivity of the silicone material decreased with thermal aging. This is especially pronounced for the thermally aged silicone when probed at 150° C. and low frequencies. Similarly, the loss permittivity is reduced with thermal aging. A decrease in stiffness at temperatures below 60° C. is observed in the DMA storage modulus after thermal aging. Thermal aging further caused the relaxation peak to decrease in intensity and shift (+10° C.) to higher temperatures.

The silicone's real permittivity increased with mechanical aging. An exception is the low frequency (<0.1 Hz) behavior at 150° C. This change at elevated temperature is also observed in lowered permittivity loss. Mechanical aging reduced the permittivity loss (now observable at frequencies below 100 Hz). The silicone lost stiffness at low temperatures with mechanical aging. Mechanical aging shifted (−10° C.) the relaxation peak. The temperature of the mechanical aging treatment appears to have only a minor effect.

The trends in real permittivity after electrical aging followed the same trends as observed for the silicone after mechanical aging. The trends in dynamic moduli, however, were markedly different. Electrical aging resulted in increased stiffness and shifts (+10° C.) in the relaxation peak to higher temperatures. Only minor differences were found after aging at room temperature vs. aging near the high temperature transition.

Epoxy+Fiberglass Laminate (Fr5)—Thermal aging of the epoxy laminate caused a small increase in both the real permittivity and the loss permittivity. Very high permittivity loss at measurement temperature of 150° C. is observed regardless of aging. This product should be used with caution in applications at and above 150° C. With thermal aging, the dynamic stiffness is observed to have decreased for temperatures below the glass transition. Concurrently, the loss modulus peak is observed to decrease in intensity and shift (+10° C.) to higher temperature. A second, minor relaxation is observed at 80° C. after thermal aging. This behavior is similar to that observed with thermal aging of the neat epoxy.

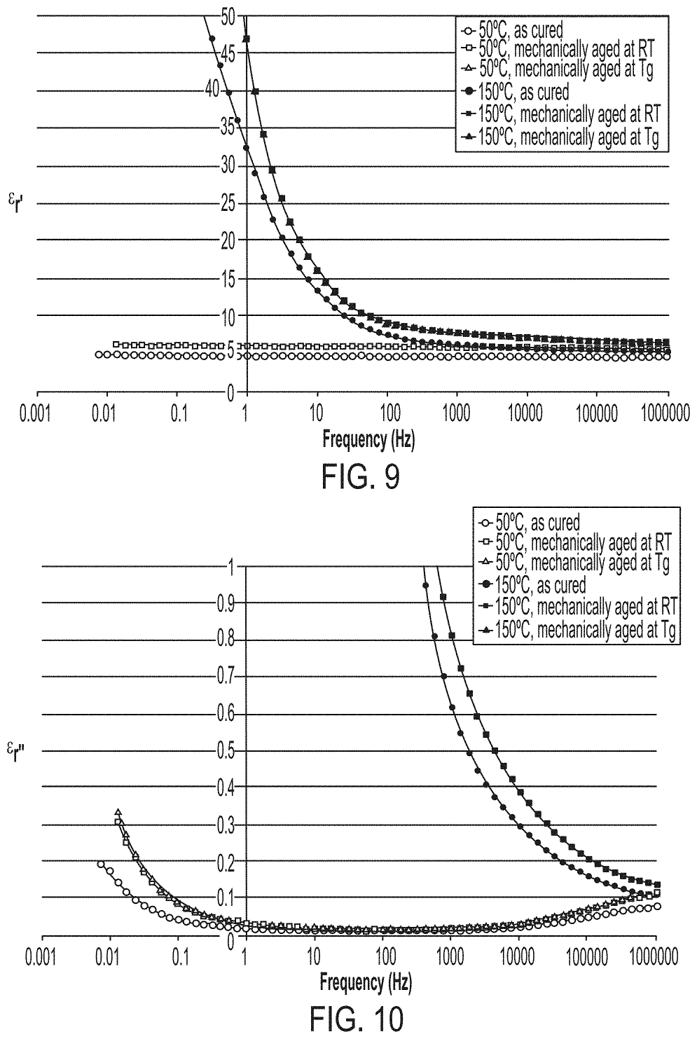

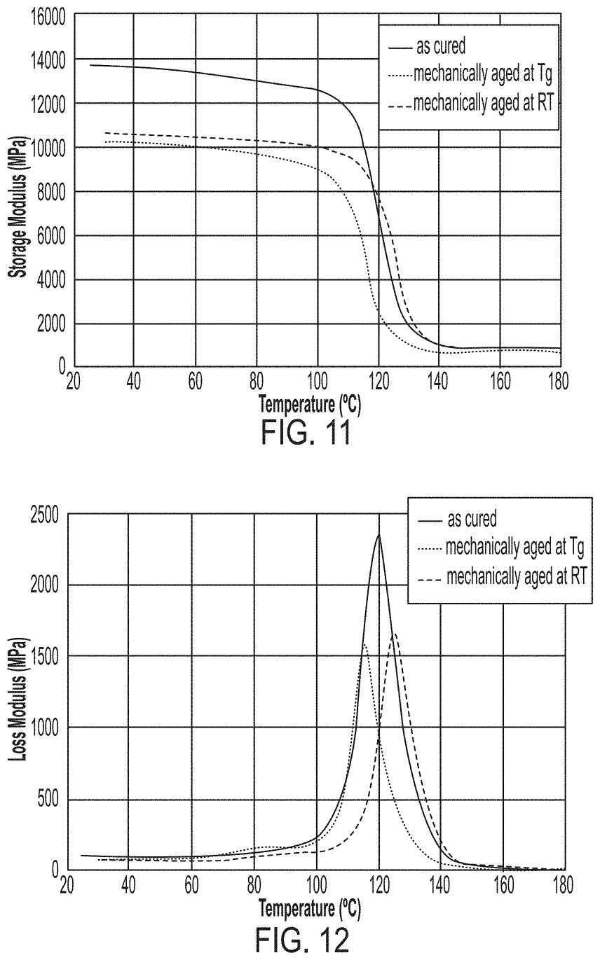

Mechanical aging of the epoxy laminate increases both the real permittivity (FIG. 9) and the loss permittivity (FIG. 10) across the spectrum at both 50° C. and 150° C. The temperature of the mechanical aging treatment (room temperature or glass transition temperature) has no effect. The storage modulus shows a decrease in stiffness with mechanical aging (FIG. 11). The loss modulus peak intensity decreased by almost the same amount with mechanical aging at both aging temperatures (FIG. 12). (The reduction is more pronounced at lower temperatures for the material aged at room temperature and at higher temperature for the material aged at the glass transition.) There is a possible minor relaxation observed near 80° C. for both aged materials.

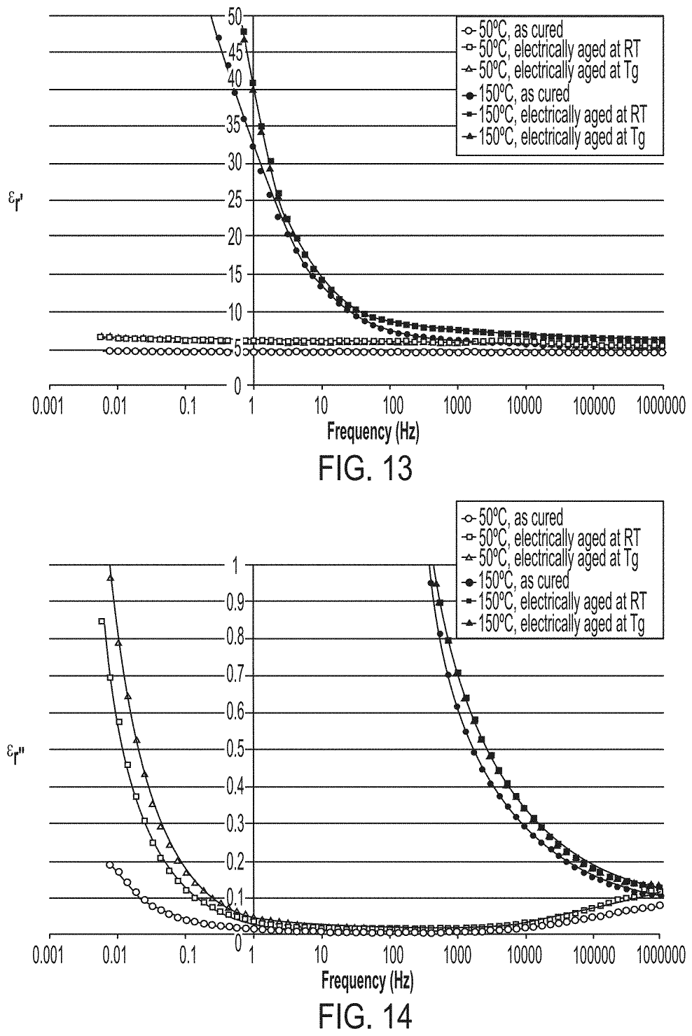

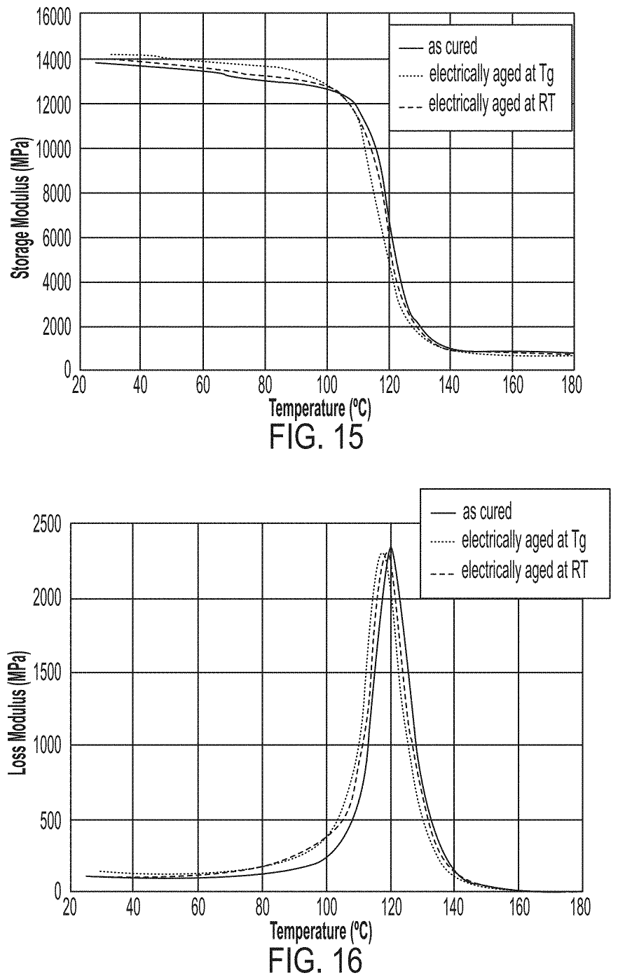

The effects of electrical aging on both the real and loss permittivities are the same as observed for mechanical aging (FIGS. 13-16). The real dynamic elastic moduli and loss moduli were unaffected by electrical aging (FIGS. 15-16). The temperature at which electrical aging was applied had no discernable effect on the epoxy laminate.

Silicone+Fiberglass Laminate (G7)—The real permittivity of the thermally aged silicone laminate increased across the frequency range when measured at 50° C. An increase in real permittivity at 150° C. was only observed at frequencies below 1 Hz. An increase at 150° C. was also observed in the permittivity loss of the thermally aged material. Thermal aging appears to have essentially no effect for sample G7 when loss permittivity is measured at 50° C. Stiffness is reduced at temperatures below 120° C. and increased above this temperature. Also observed is a large reduction in the very broad loss modulus peak with thermal aging.

Both mechanical aging treatments of the G7 laminate caused increases in real permittivity across the frequency spectrum. The room temperature mechanical aging appears to have a slightly greater effect. This is true of the loss permittivity, as well, although the differences between the as cured laminate and the mechanically aged laminates are minor. Dynamic storage moduli decreased with mechanical aging across the temperature range measured. A decrease in the dynamic loss moduli is only observed above 100° C. with both mechanical treatment. The broad loss modulus peak is still apparent.

The effects of electrical aging are similar to those of mechanical aging. However, the temperature of electrical aging has no impact. A slight decrease in dynamic storage moduli is observed over the temperature range. An increase in dynamic loss moduli was measurable over this same range.

Three complimentary characterization techniques were evaluated on as-cured, thermally aged, mechanically aged, and electrically aged samples of the epoxy resin, Pn-0 (Permafil 74050) and the silicone resin, Sn-0 (Silres H62c). Prepared samples were sent to Particle Testing Authority (a service lab affiliated with Micrometrics Instrument Corporation) for pycnometry, N2 porosimetry, and specific surface area (BETA). There are differences in the material microstructures observed after all three types of aging.

Pycnometry—The density values produced from pycnometry characterizations are listed in Table 2. Thermal aging reduced density for both the epoxy (Pn-0) and the silicone (Sn-0). Density increased with mechanical aging at room temperature and at the glass transition temperature. The density increase was only slightly greater with mechanical aging at the glass transition than at room temperature for the epoxy. The converse was observed for the silicone.

TABLE 2
Pycnometry results for cured epoxy and silicone resin materials

| | | Density | Std Dev | Ratio |
|---|---|---|---|---|
| No. | Sample Description | (g/cm³) | (g/cm³) | (/no aging) |
| 2001837 | Epoxy as cured | 1.1899 | 0.0015 | 1.0000 |
| 2001838 | Epoxy 100 hr at 155° C. | 1.1820 | 0.0045 | 0.9934 |
| 2001839 | Epoxy mechanically aged | 1.2043 | 0.0003 | 1.0121 |
| | at room temp | | | |
| 2001840 | Epoxy mechanically aged | 1.2058 | 0.0003 | 1.0134 |
| | at Tg | | | |
| 2005006 | Epoxy electrically aged at | 1.2057 | 0.0007 | 1.0133 |
| | room temp | | | |
| 2001841 | Silicone as cured | 1.1681 | 0.0008 | 1.0000 |
| 2001842 | Silicone 100 hr at 155° C. | 1.1575 | 0.0011 | 0.9909 |
| 2001843 | Silicone mechanically aged | 1.1733 | 0.0011 | 1.0045 |
| | at room temp | | | |
| 2001844 | Silicone mechanically aged | 1.1694 | 0.0014 | 1.0011 |
| | at Tg | | | |
| 2005008 | Silicone electrically aged at | 1.1829 | 0.0045 | 1.0126 |
| | room temp | | | |

Electrical aging at room temperature also caused an increase in the density of the epoxy. This increase was essentially the same as observed with mechanical aging. Electrical aging of the silicone also resulted in an increased density. However, the density increase with electrical aging was significantly greater than for mechanical aging.

A density increase can indicate reduced free volume, which often accompanies structural ordering. The measured changes in density are commensurate with the changes observed in real permittivity trends with aging treatments.

BET surface area—The BET surface area data is listed in Table 3. Thermal aging reduced total specific surface area for the epoxy but increased the surface area for the silicone. The reduction in specific surface area for the epoxy is not anticipated from a reduced density. The thermally aged silicone increased surface area with reduced density. The silicone incurs the largest changes at elevated temperatures. All mechanically aged samples indicated large reductions in specific surface areas.

TABLE 3
Specific surface area (BET) results for cured epoxy and silicone resin materials

| | | Single point surface | BET (Kr) specific | Ratio |
|---|---|---|---|---|
| No. | Sample description | area (m²/g) | surface area (m²/g) | (/no aging) |
| 2001837 | Epoxy as cured | 0.0115 | 0.0133 | 1.0000 |
| 2001838 | Epoxy 100 hr at | 0.0109 | 0.0124 | 0.9323 |
| | 155° C. | | | |
| 2001839 | Epoxy mechanically | 0.0047 | 0.0051 | 0.3835 |
| | aged at room temp | | | |
| 2001840 | Epoxy mechanically | 0.0076 | 0.0085 | 0.6391 |
| | aged at Tg | | | |
| 2005005 | Epoxy electrically | 0.0012 | 0.0017 | 0.1278 |
| | aged at room temp | | | |
| 2001841 | Silicone no aging | 0.0081 | 0.0092 | 1.0000 |
| 2001842 | Silicone 100 hr at | 0.0095 | 0.0130 | 1.4130 |
| | 155° C. | | | |
| 2001843 | Silicone mechanically | 0.0020 | 0.0030 | 0.3261 |
| | aged at room temp | | | |
| 2001844 | Silicone mechanically | 0.0016 | 0.0017 | 0.1848 |
| | aged at Tg | | | |
| 2005008 | Silicone electrically | 0.0050 | 0.0098(?) | 0.6173 |
| | aged at room temp | | | |

Although the trends appear valid, two factors discourage further interpretation of these surface area results. First, the amount of surface area accessible for measurement is very low, which affects confidence. Second, the technique requires access by pressurized Kr through the sample surface into the bulk of the sample. Variations in the sample surfaces could affect this access.

The type of stress that produces aging has a pronounced effect on the aging behaviors for all four materials. For the controlled aging treatments used here, the molecular dynamics in the sample material after thermal aging are distinct from the molecular dynamics after mechanical or electrical aging. Thermal aging and mechanical or electrical aging produce differing structural changes. It follows that mechanical aging and electrical aging cannot be treated simply (e.g., as resulting from adding thermal energy, such as from friction, to a molecular structure). A representative kinetic model will need to accommodate this finding. The term “dynamic field aging” is used to refer to both mechanical and electrical aging as applied here.

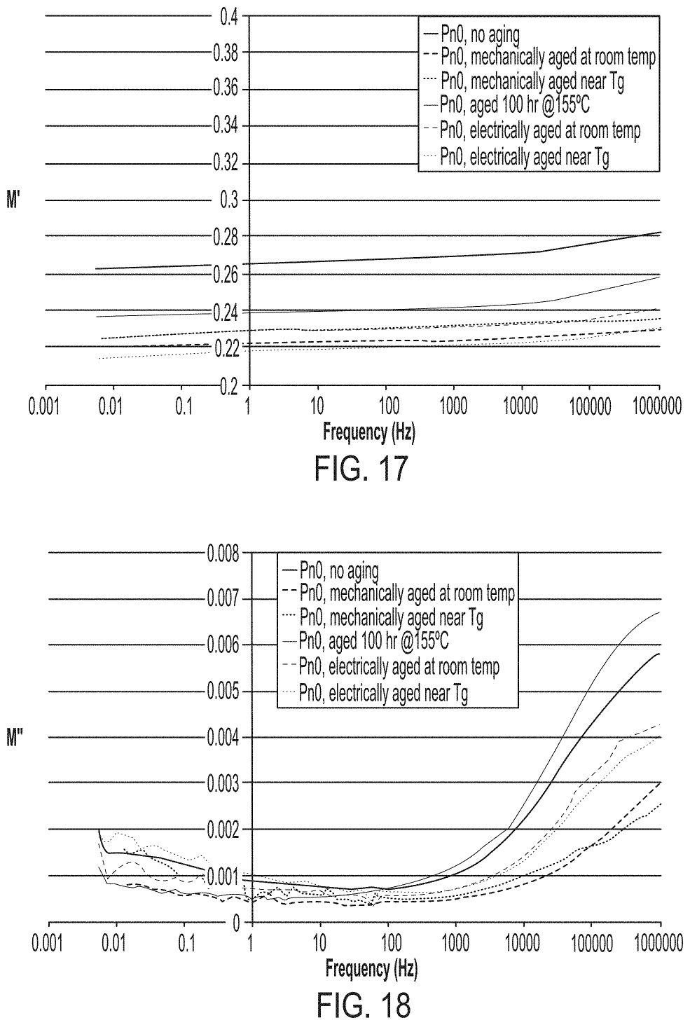

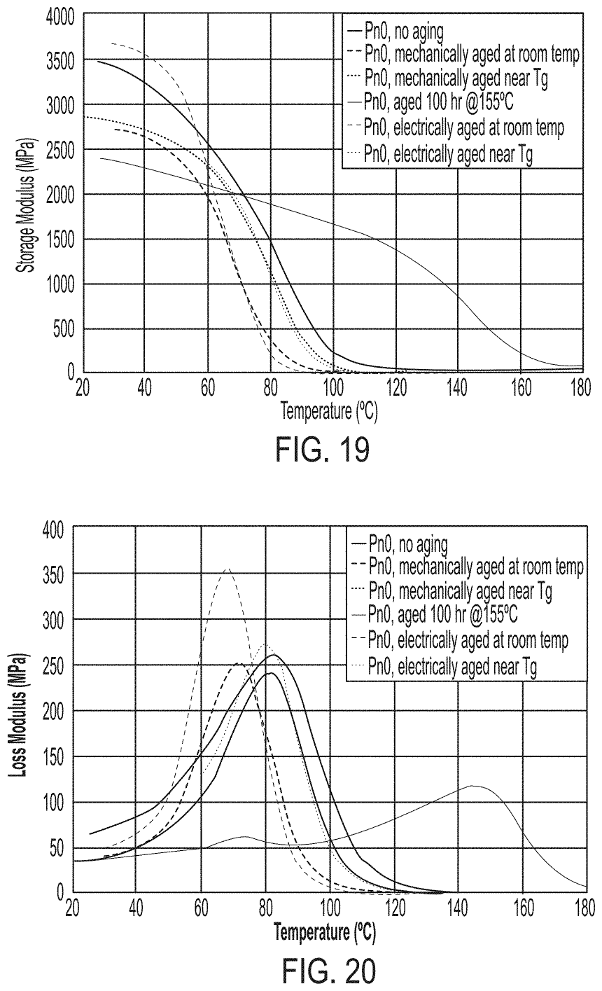

The comparative graphs (FIGS. 17-24) give evidence that mechanical or electrical aging is not due to a heating effect. The resulting behaviors do not imitate those observed after thermal aging. For brevity of this discussion, the data shown are limited to those measured at room temperature after aging. Dielectric moduli are graphed instead of permittivity. The pycnometry and BET data are used to help interpret the results.

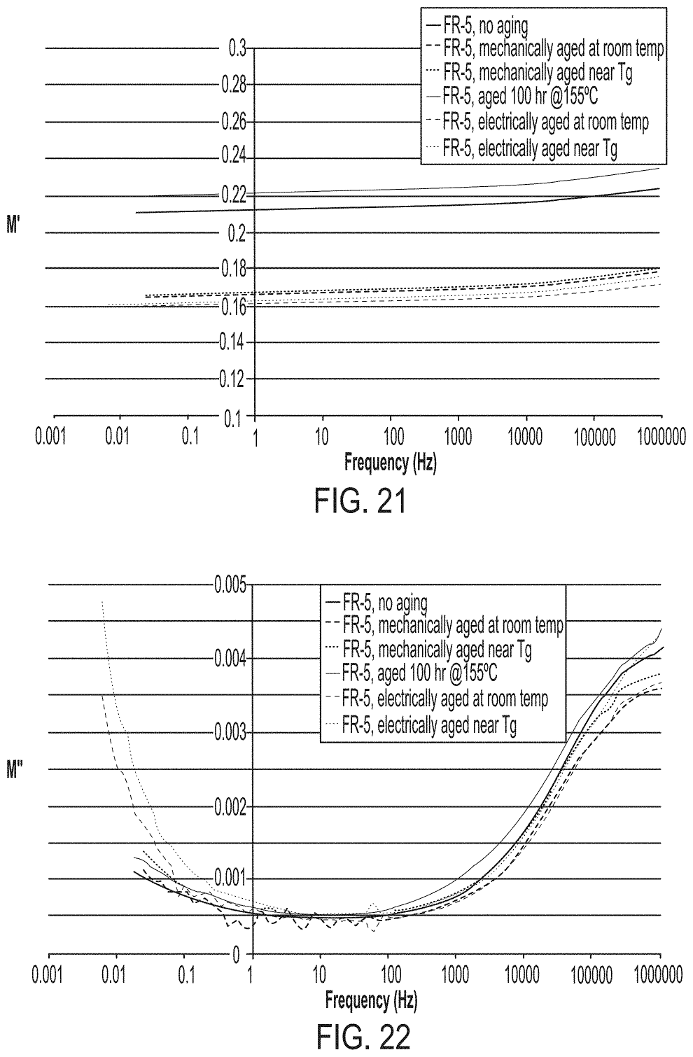

The similarities of behaviors after mechanical aging and electrical aging illustrated by the dielectric moduli and mechanical moduli of the epoxy and silicone are in agreement with changes in density. Density changes, however, do not provide a full explanation. An inverse proportionality is expected between the dielectric storage modulus and both the dipole concentration and the dipole moment. With no change in dipole moment, the dipole concentration should be proportional to density. The dielectric storage moduli for the epoxy decrease with mechanical or electrical aging compared to epoxy with no aging (FIG. 17). Increases in density are also observed. The dielectric storage modulus of the epoxy laminate similarly changed with mechanical or electrical aging (FIG. 21). For both mechanically aged silicone materials, the dielectric moduli decrease almost the same amount across the spectrum (compared to the silicone with no aging). Both exhibited increases in density. The thermally aged silicone developed an increase in dielectric storage modulus. The density for the silicone decreased with thermal aging. The dielectric loss moduli for both epoxy and silicone demonstrated essentially the same behaviors after thermal and mechanical aging as those of the unaged materials. At 155° C., the thermally aged silicone is well above its sub-room temperature relaxation. During thermal aging at 155° C., nano- and microscopic regions of the silicone may respond more actively to stress relaxation.

The density of the thermally aged epoxy also decreased compared to the unaged density. However, the dielectric storage modulus of the thermally aged epoxy decreased significantly. This suggests that the phase separation existing after thermal aging could increase the specific mean-squared dipole moment of the epoxy material. Mechanical loss moduli as a function of temperature show evidence of phase separation in the epoxy. After thermal aging, a new, higher temperature relaxation peak is present. This phase separation was not observed after the mechanical or electrical aging treatments (FIG. 20).

Phase separation of the epoxy laminate FR5 after thermal aging is also observed (FIG. 24). There is a suggestion of phase separation in the epoxy laminate after mechanical aging, as well (see the mechanical loss modulus as a function of temperature in FIG. 24). A peak at lower temperature appears after mechanical and thermal aging. The high temperature relaxation is active in the mechanical moduli of the as-received epoxy laminate.

The epoxy laminate's dielectric storage modulus is observed to decrease with mechanical aging in the same manner as for the epoxy. However, thermal aging caused this modulus to increase slightly in comparison to the unaged epoxy laminate. The dielectric loss moduli appear unaffected by the five aging treatments. The silicone laminate's dielectric storage modulus was also observed to decrease with mechanical or electrical aging in the same manner as for the silicone. However, thermal aging caused this modulus to decrease slightly in comparison to the as-received silicone laminate. Only the mechanical aging at room temperature caused the dielectric loss moduli to differentiate, resulting in increased losses at frequencies below 1000 Hz.

Aging in proximity to the glass transition—At active structural relaxations (e.g., near the glass transition), storage moduli undergo a rapid decrease with increasing temperature and loss moduli develop a peak with higher intensity. Aging treatments applied at temperatures of high loss (e.g., maxima in damping) could lead to an informative difference in behavior from aging at temperatures well above or below the maxima. The epoxy glass transition is observed within the range of the reported characterizations. It is important to note that the silicone exhibits a glass transition well below room temperature. The silicone relaxations observed in the graphed data are for molecular dynamics changes occurring above that glass transition. The temperature of aging referred to here as T_{g} should be considered a second glass transition temperature. Differences in general moduli trends have been described for the epoxy and silicone (see above). Although the overall mechanical or electrical aging for epoxy and silicone was similar, there are a few notable exceptions.

The epoxy dielectric storage and loss moduli are less sensitive to the temperature of aging than to the type of aging (i.e., electrical or mechanical). The mechanical storage and loss moduli, however, show more change after aging at room temperature than after aging in the glass transition. The changes in epoxy laminate dielectric storage and loss moduli (with mechanical and electrical aging) appear independent of the temperature of application. This is also observed for the mechanical moduli. The silicone electrically aged near the second glass transition temperature has the greatest change in dielectric storage modulus. The dielectric loss moduli are essentially unchanged with aging. The mechanical storage modulus only showed differences at low temperatures (<60° C.) due to aging temperature. Here the mechanically aged and electrically aged silicone were both more sensitive to aging near the second glass transition temperature. Aging of the silicone laminate was independent of temperature except for electrical aging near the transition temperature. This condition showed a marked decrease in dielectric storage modulus and increase in loss modulus at low frequencies. The mechanical storage and loss moduli also showed little effect on the temperature of mechanical or electrical aging. The exception is the loss moduli for the laminate electrically aged at room temperature, which exhibited increased loss.

DETA & DMA Correlation—Based on the physical models for molecular dynamics that have been developed over the last three decades, the investigation of aging phenomena suggests a correlation between DETA and DMA for aging behaviors. The suggested correlation has not been previously described in the literature. The correlation, itself, could support an improved phenomenological understanding of the differences in thermal, mechanical, and dielectric aging behaviors.
1) At power frequencies (below 1 MHz) in dielectric materials having an amorphous “matrix” (at least partially amorphous), external stimuli produce molecular dynamics that can be viewed as a combination of phonons and associated non-phonons.
2) The non-phonons (due to phonon scattering by elastic or dielectric inhomogeneities) vary in intensity with frequency and temperature.
3) Dynamic elastic moduli derived from DMA may be related to acoustic phonons and non-phonons. Acoustic phonons may represent collaborative motion of “locations” or “regions” that display distinct momentum.
4) Dielectric moduli derived from DETA may be related to optical phonons and their non-phonons. Optical phonons represent opposing motion of dipolar “regions”.
5) DETA and DMA moduli may show that the “momentum regions” and the “dipolar regions” are not independent.
6) Theoretical proof could be achieved by a density of states analysis for the “disordered extended modes” (Broadband Dielectric Spectroscopy. eds. F. Kremer and A. Schonhals, Springer (2003)).
7) Observations of “growing length scales” with aging (Corberi et al., Growing length scales in aging systems. Chpt. 11, Dynamical Heterogeneities in Glasses, Colloids and Granular Media, eds. L. Berthier et al., (2011) Oxford University Press) further support these findings and this approach.

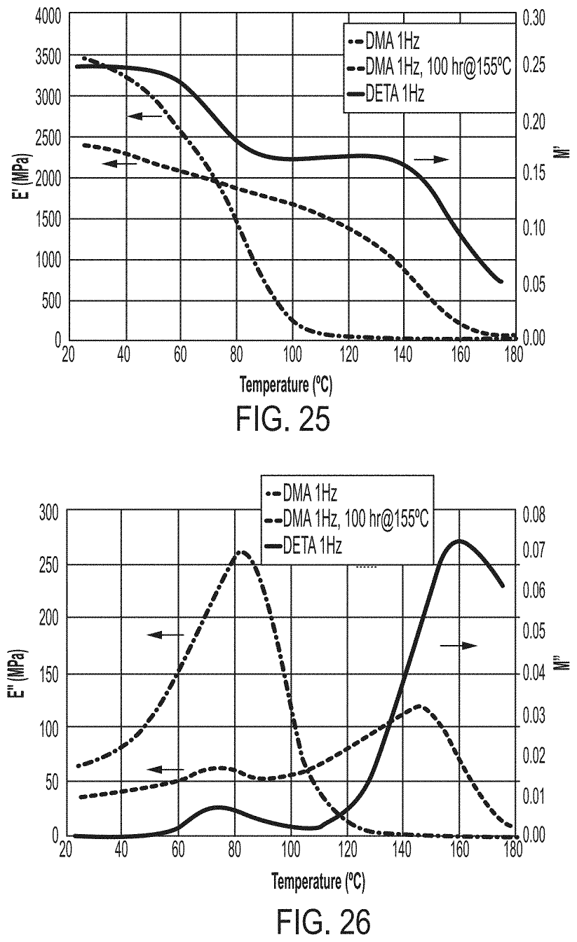

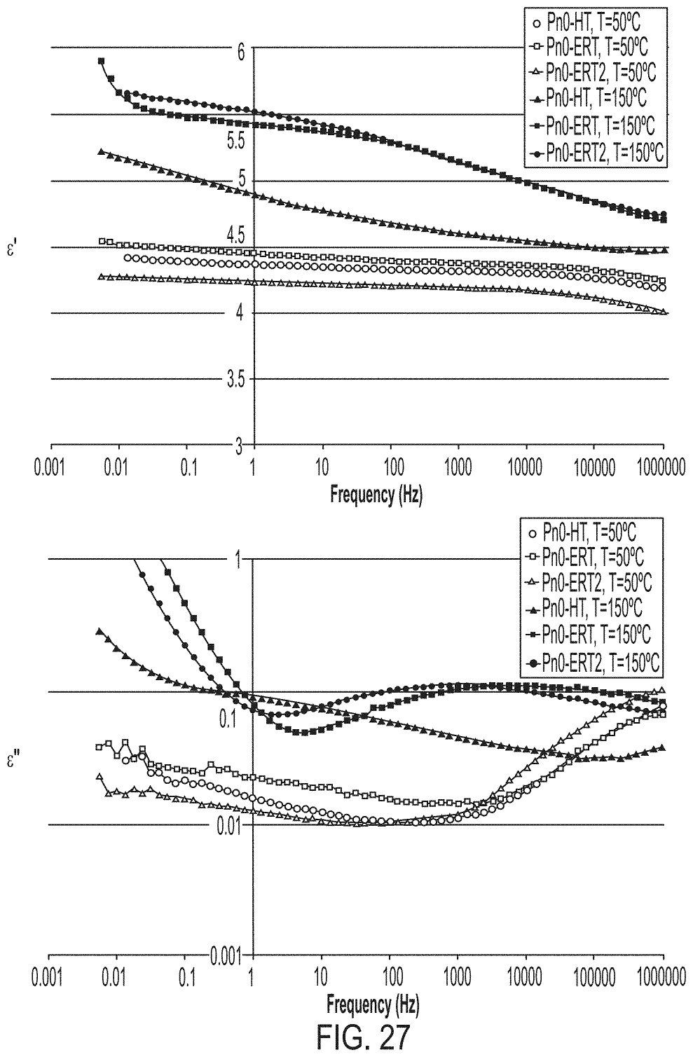

FIG. 25 is a graph of the dynamic elastic storage modulus and the real dielectric modulus as a function of temperature for epoxy (cured Permafil 74050 resin). FIG. 26 is a graph of the dynamic elastic loss modulus and the imaginary dielectric modulus as a function of temperature. The data includes dielectric moduli from DETA for the as-cured epoxy, and elastic moduli from DMA for both the as-cured and the thermally aged epoxy. Unlike the rest of the DETA data herein, here the data is shown at a constant frequency of 1 Hz as a function of temperature. A similar comparison could be made on a limited frequency scale. (A frequency domain comparison would require either a time-temperature-transposition of low frequency data (inadvisable if the spectra are anticipated to vary in number of bands) or availability of acoustic DMA apparatus. Shear moduli are anticipated to show more precise correlation with dielectric moduli.)

The changes in the real and imaginary elastic moduli for epoxy with thermal aging were described above as suggesting a phase separation. A new relaxation after thermal aging near 145° C. and a reduced intensity of the original relaxation at ˜75°-82° C. is observed. Prior to thermal aging, the dielectric moduli depict both relaxations. One possible explanation is that the optical phonon+non-phonon dynamics are active in two structural “regions” in the as-cured epoxy. Only after significant time for structural relaxation above the glass transition temperature, the acoustic phonon+non-phonon dynamics also become active in the second structural region. Considering that the acoustic phonons require cooperative molecular dynamics, this appears reasonable. The thermal aging produces structural changes (density fluctuations) that are more accommodating to a new acoustic phonon.

Sequential aging—Serial aging treatments were carried out for cured silicone resin (Sn0) and cured epoxy resin (Pn0). Thermal aging (100 hrs @ 155° C.) after electrical aging did not remove the effect of electrical aging but there is a small reduction in its effect. For Sn0, additional electrical aging caused a slightly greater effect. With Pn0, additional electrical aging caused a slightly reduced effect. Changes in dielectric response due to phase separation are believed to be complicating the aging behavior observed for Pn0. The real permittivity (ϵ′) and imaginary permittivity (ϵ″) for three Pn0 samples are shown in FIG. 2. More specific observations are the following:
1) Real permittivity of aged silicone: The ϵ′ for electrically aged silicone (Sn0-ERT) was 22% higher at 50° C. and 20% higher at 150° C. as compared with that of the heat-treated silicone (Sn0-HT). Sn0 samples heat-treated after electrical aging maintained ˜20% increase in ϵ′ at both temperatures (Sn0-ERT-HT). The percentages are listed in Table 4.
2) Imaginary permittivity of aged silicone: At 50° C., ϵ″ was lowest for the heat-treated sample. At 150° C., samples that received both electrical aging and heat-treatment had significantly higher imaginary permittivity at frequencies below 10 Hz. All Sn0 samples exhibited the same low frequency behavior dependent on temperature.
3) Real permittivity of aged epoxy: The ϵ′ at 50° C. after electrical aging (Pn0-ERT) was 5% higher than that of the heat-treated epoxy (Pn0-HT). After the second electrical aging, Pn0-ERT2 had a small reduction in real permittivity across the frequency range. At 150° C., the real permittivities of the electrically aged samples showed similar behavior. The broad band at 10²-10³ Hz suggests phase separation. This band was not observed in the heat-treated sample. The difference in real permittivity at 150° C. with both electrical aging treatments is larger at ˜12%.
4) Imaginary permittivity of aged epoxy: The outstanding features of the imaginary permittivity are the appearance of a relaxation peak at 1000 Hz with electrical aging (thought to be a shift of the ˜1 MHz B-relaxation to lower frequencies); and the large increase at 150° C. in ϵ″ at frequencies below 1 Hz.

TABLE 4
Percentage change in real permittivity at 1 Hz,
compared with heat-treatment only

| | Temperature | | |
|---|---|---|---|
| Sample | (° C.) | ϵ′ | % |
| Sn0-HT | 50 | 2.97 | |
| Sn0-ERT | 50 | 3.62 | 22 |
| Sn0-ERT + HT | 50 | 3.56 | 20 |
| Sn0-ERT + HT + ERT | 50 | 3.65 | 23 |
| Sn0-HT | 150 | 2.91 | |
| Sn0-ERT | 150 | 3.48 | 20 |
| Sn0-ERT + HT | 150 | 3.43 | 18 |
| Sn0-ERT + HT + ERT | 150 | 3.5 | 20 |
| Pn0-HT | 50 | 4.24 | |
| Pn0-ERT | 50 | 4.45 | 5 |
| Pn0-ERT2 | 50 | 4.36 | 3 |
| Pn0-HT | 150 | 4.9 | |
| Pn0-ERT | 150 | 5.43 | 11 |
| Pn0-ERT2 | 150 | 5.52 | 13 |

DETA of polymer matrix composites: nano-silica modified—Modification of an epoxy thermoset and a silicone thermoset by the addition of nano-silica caused small changes in the dielectric behaviors. Larger property changes were observed for the dynamic elastic moduli. The dielectric behavior of the modified and aged epoxy is similar to that of the neat epoxy. DETA at temperatures below room temperature allowed exploration of the B-relaxation. Pn0 is the neat thermoset epoxy polymer cured from commercial resin Permafil 74050 from Von Roll. Pt0 is Permafil 74050T, the same resin as 74050 and modified by the addition of nano-silica to provide thixotropy prior to cure.

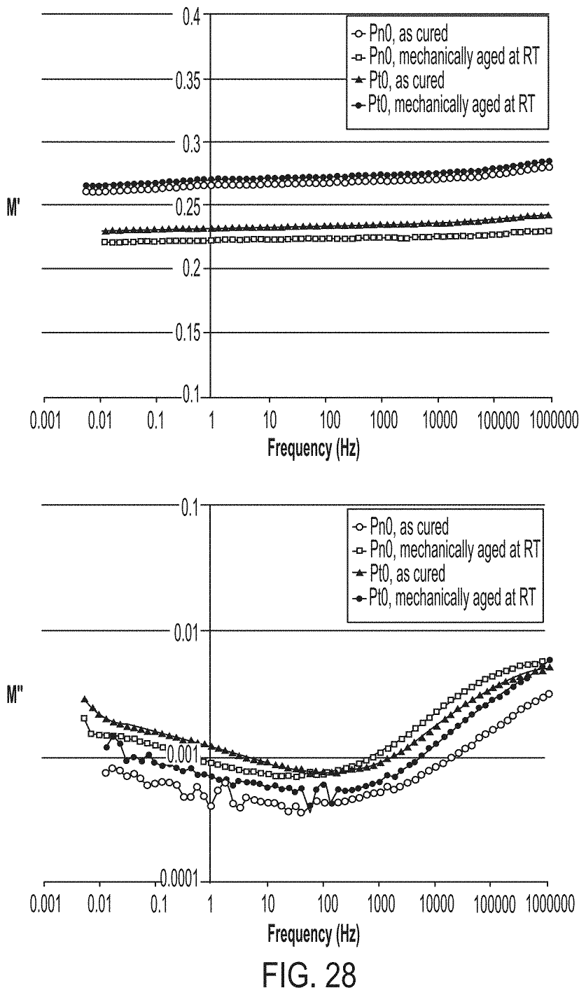

Mechanical aging of nano-silica modified epoxy—Samples of Pt0 and Pn0 were mechanically aged at room temperature. DETA spectra were then produced. The spectra shown in FIG. 28 were measured at 30° C. The electric moduli of Permafil epoxy show evidence of mechanical aging both with and without nano-silica modification. Pn0 and Pt0 respond to mechanical aging in the same manner: the real moduli decrease. The imaginary moduli also indicate a small decrease across the spectrum.

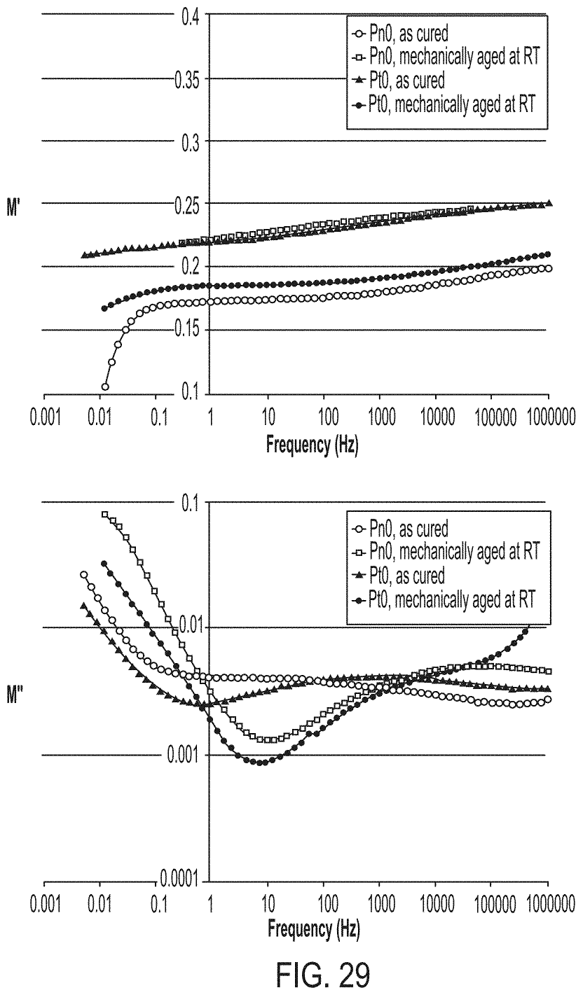

Phase separation was observed in unfilled Pn0 as cured. The effect of phase separation is observed above 77° C. as a relaxation mode in both M′ and M″. This mode moves to higher frequencies as temperature increases. FIG. 29 shows data measured at 150° C. The phase separation mode is centered around ˜50 Hz at 100° C. and 10⁴ Hz at 150° C. for the mechanically aged epoxy; and around ˜50 Hz at 100° C. and 10³ Hz at 150° C. for as-cured epoxy. Mechanical aging appears to encourage the phase separation behavior. The presence of nano-silica does not seem to impact the phase separation behavior of the matrix, although the MWS-relaxation and that due to the phase separation appear in the same frequency range at high temperatures. Any change in MWS-relaxation due to mechanical aging would be observed above 77° C. in the imaginary moduli.

DETA of PMC: mica-filled—Mica continues to be used in most power-dense insulation systems as its presence provides improved voltage endurance when fully encapsulated by a polymer matrix. The mechanism of this improvement is not fully understood. By its very nature, mica contains a considerable quantity of potassium, fluorine, and hydroxyl ions. The presence of these ions should increase the low frequency polarizability of the polymer matrix composite, particularly as temperature rises. The PMC with mica reported here are:
Pm0: Permafil 74050 epoxy (Pn0) with 1 wt. % synthetic muscovite
Sm0: H62c silicone (Sn0) with 1 wt. % synthetic muscovite
ME: commercial mica board consisting of ˜90 wt. % muscovite and 10 wt. % epoxy
MS: commercial mica board consisting of ˜90 wt. % muscovite and 10 wt. % silicone

Mica-Filled PMC compared with Neat Polymer—The real permittivity of Pm0 (1 wt. % mica in epoxy) precisely matches that of Pn0-HT (neat epoxy after heat treatment) at 50° C. At 150° C., the real permittivity of Pm0 has increased above that of Pn0-HT. The imaginary permittivity of Pm0 again mirrors that of Pn0-HT with a pronounced increase at <1 Hz at both 50° C. and 150° C. At 150° C., a broad relaxation is visible around 1000 Hz.

The permittivities of Sm0 (1 wt. % mica in silicone) show similar trends. The real permittivities are higher at both 50° C. and 150° C. as compared with the neat silicone materials; but maintain the low slope of the heat-treated silicone, Sn0-HT. The imaginary permittivities again mirror those of Sn0-HT for both temperatures. There is an indication of a relaxation around 10³ Hz only at 150° C., but the resolution is poor due to noise at the higher frequencies.

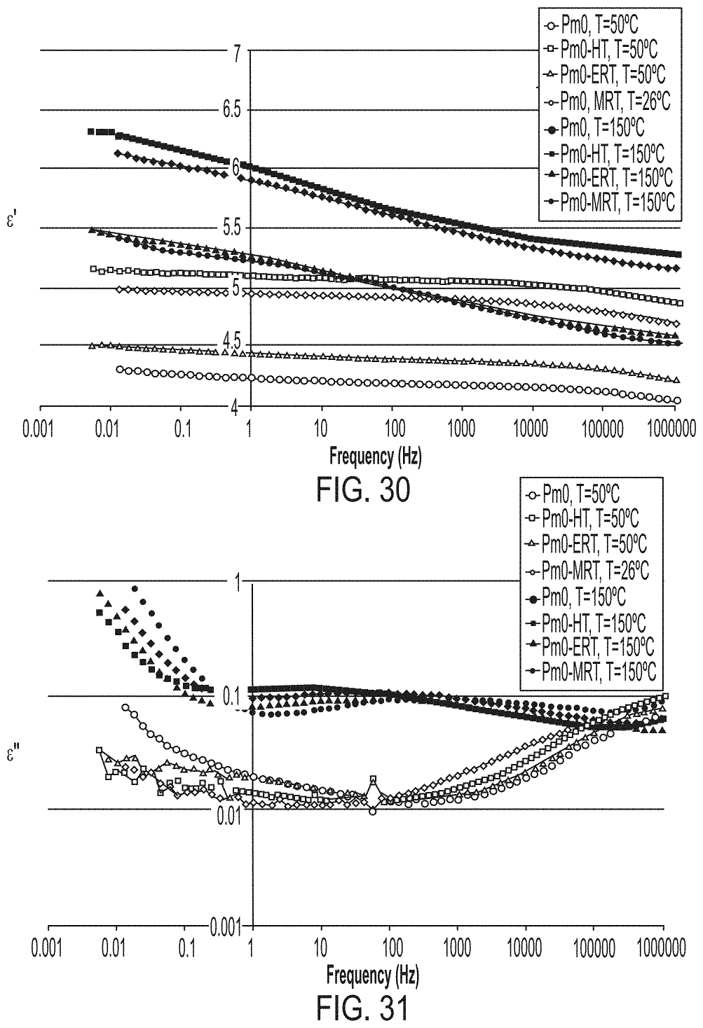

Aging of Mica-Filled PMC—FIGS. 30-31 show the real and imaginary permittivity spectra for Pm0 with various treatments. Pm0-HT was thermally aged, Pm0-ERT was electrically aged, and Pm0-MRT was mechanically aged. DETA was then conducted on the prepared samples. The real permittivities indicate the same general trends with frequency at both temperatures shown. However, the thermal aging appears to have minimal impact, whereas the real permittivities after electrical aging and mechanical aging both show the same pronounced increase in permittivity across the spectrum. The increase in real permittivity with thermal aging was also observed in the neat epoxy, Pn0-HT, but the values here are slightly higher. It is suggested that these uniform differences represent changes in density due to the treatments.

The imaginary permittivities show the typical behavior of thermoset polymers for this frequency range. The imaginary permittivities increase at frequencies less than 1 Hz. This increase is accentuated at 150° C. At 10⁶ Hz, the imaginary permittivities are on the same order of magnitude for both 50° C. and 150° C. At 150° C., all indicate an additional broad relaxation around 10³ Hz, suggested to be the MWS-relaxation.

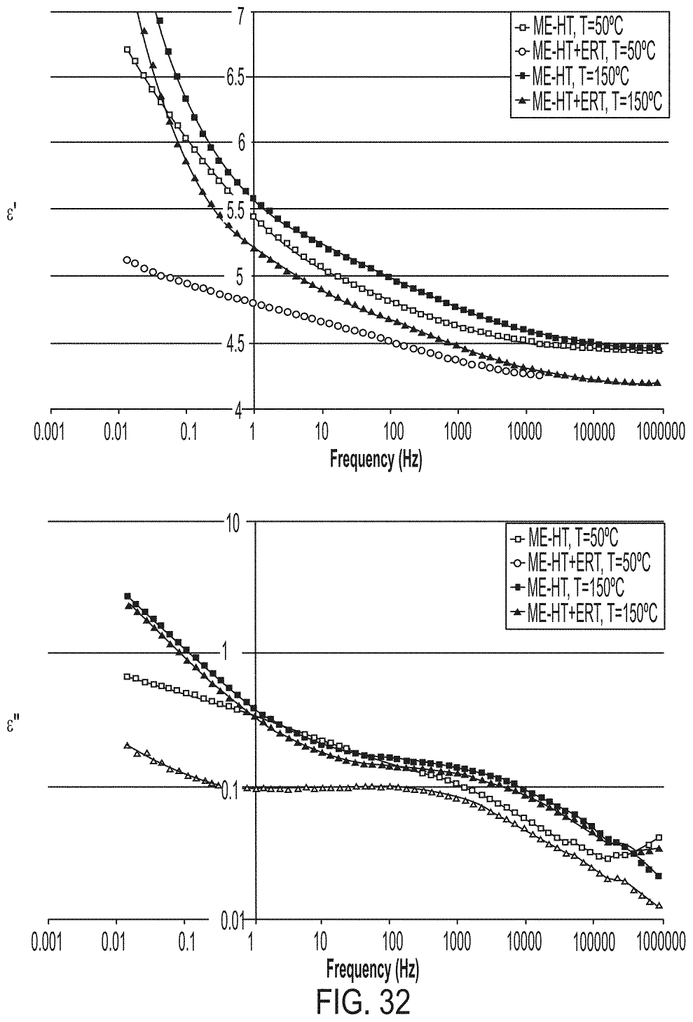

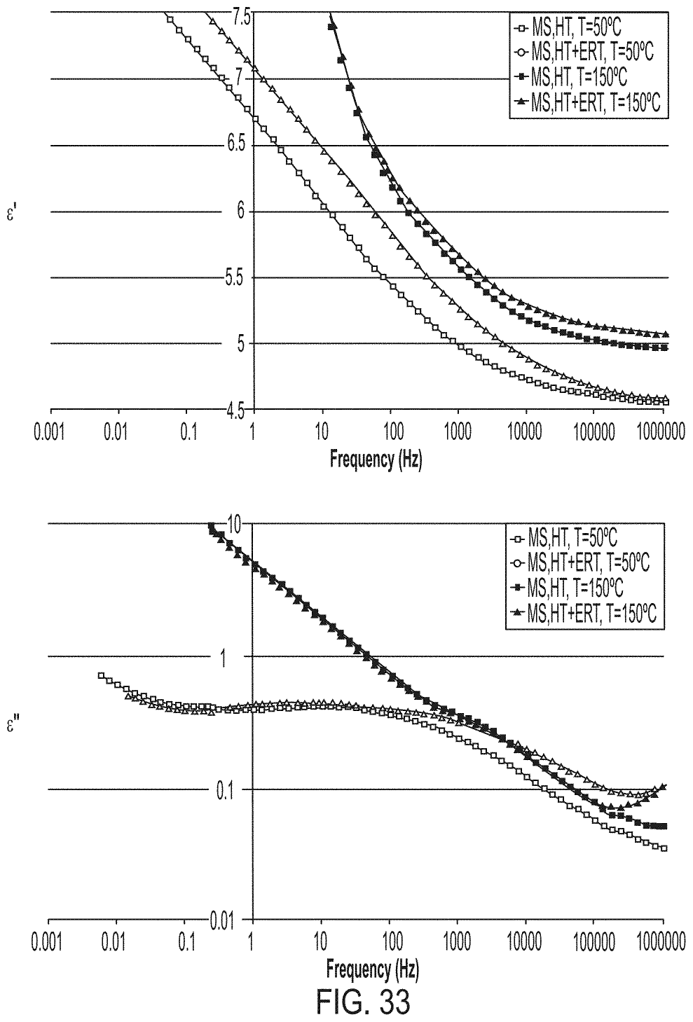

The permittivities for 90% mica PMC after thermal aging and thermal aging+dynamic electric aging are shown in FIGS. 32-33. The values are significantly higher than for PMC with low mica concentrations. Both ME and MS present high slopes decreasing towards 10⁶ Hz. The slopes are more pronounced at 150° C. then 50° C. This low frequency activity is suggested to be due to the high concentration of ions present in the mica.

The heat-treated and subsequently electrically aged ME-HT+ERT material shows a pronounced reduction in real permittivity. Interestingly, the loss permittivity is lower for ME-HT+ERT at low temperature, but the values are almost identical at high temperature. A broad relaxation is again observed around 10³ Hz at both temperatures. The effect of electrical aging on the MS material after heat treatment had less impact on permittivities within this frequency range. A slight increase in real permittivity tapering to 10⁶ Hz was observed for MS-HT+ERT at 50° C.

MWS-relaxation—The mica-filled PMC exhibit a broad relaxation around 10³ Hz in the imaginary permittivity spectra. All indications are that this is the Maxwell-Wagner-Sillars (MWS) relaxation expected of dielectric composites. With both thermoset polymer matrices, the 1 wt. % mica-filled composites presented the MWS-relaxation around 10³ Hz at 150° C. (FIG. 31). With aging treatments, the MWS-relaxation appears to shift to lower frequencies. The MWS-relaxation was not observed at 50° C. for 1 wt. % mica-filled composites. The MWS-relaxation was present for all temperatures in the imaginary permittivity spectra of 90% mica PMC. These relaxations were also more intense at the high mica concentration. Curve fitting algorithms may help to determine if the MWS-relaxation shifts in frequency with temperature and concentration. However, any such shifts present are relatively small compared with those of α-relaxations and B-relaxations.

DETA of PMC: fiberglass laminate—The two commercial fiberglass laminate PMC materials described in this section contain woven fiberglass textile and qualify for MIL-1-24768/17 (NEMA G7) and MIL-1-24678 (NEMA Fr5). These commercial laminate materials are fully processed unlike resin-impregnated fiberglass tapes used as coil windings. The dielectric behaviors of the fiberglass laminates and fiberglass tapes after cure should be similar. A full set of six aging treatments with subsequent DETA were completed.

Aging behaviors of laminate composites—The real permittivity and imaginary permittivity for both Fr5 (epoxy matrix) and G7 (silicone matrix) laminate PMC materials are compared for both as cured and aged conditions at 50° C. and 150° C. (Dielectric response at intervening temperatures were also measured.)

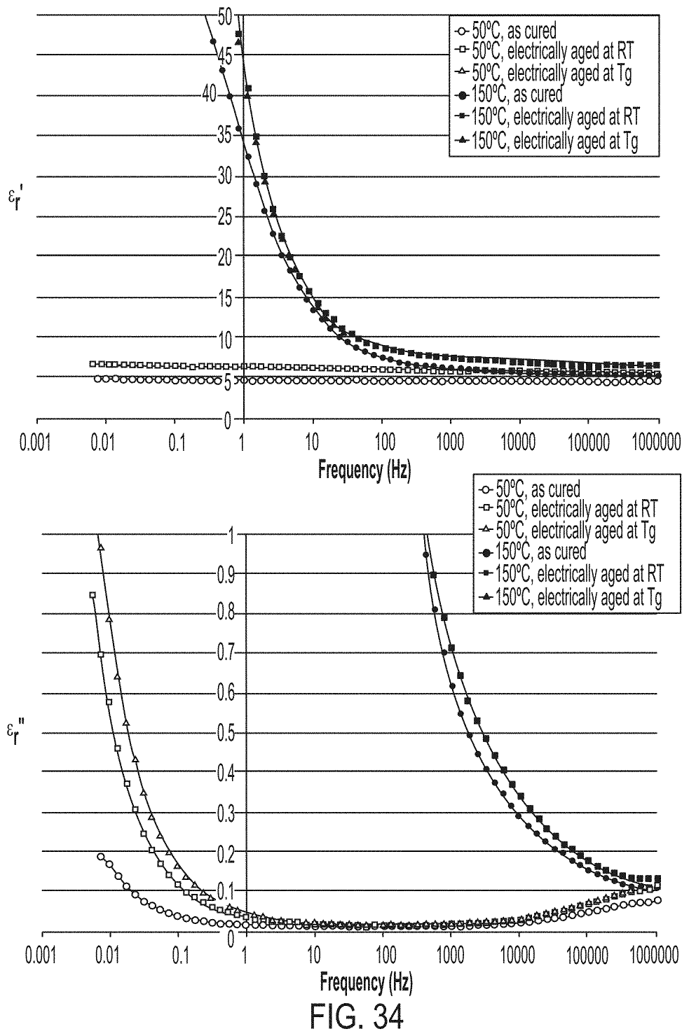

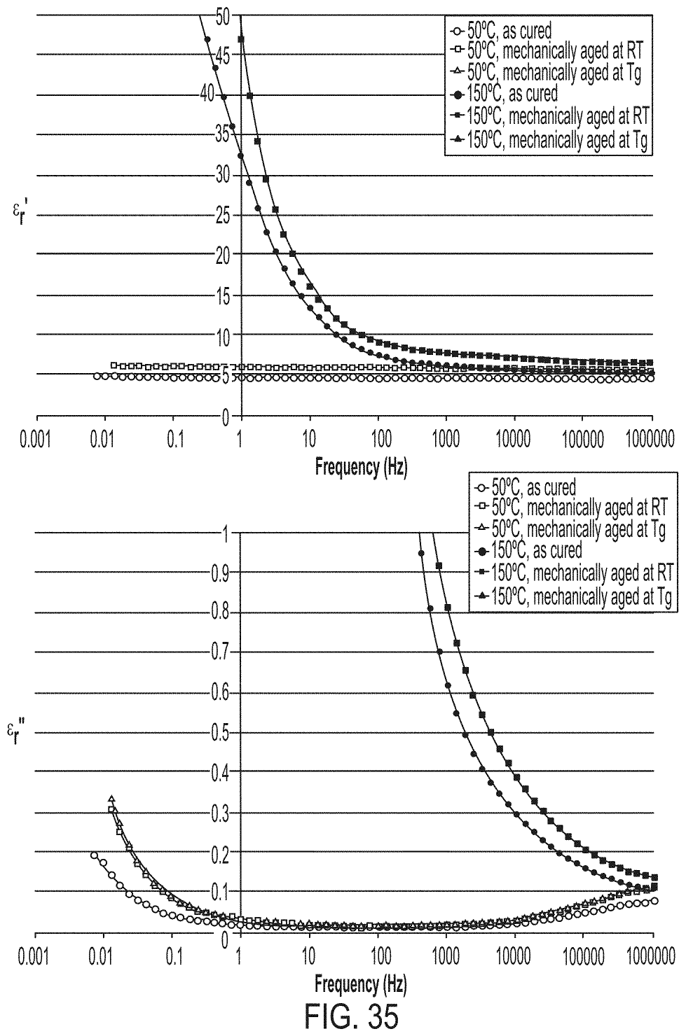

For Fr5, a significant relaxation is operational at low frequencies when 150° C. is reached. The difference with temperature for both real and imaginary permittivity was more pronounced at lower frequencies gradually tapering by 10⁶ Hz. Thermal aging produced a small shift in this relaxation towards higher frequencies. In general, no difference is detected between Fr5 when electrically or mechanically aged at room temperature or at the glass transition temperature (FIGS. 34-35). Unlike the thermally aged Fr5, the real permittivity of the dynamically aged Fr5 is observed to increase at both low frequency and high frequency by ˜15% as compared with the “as cured” condition. Based on studies with neat epoxy and silicone, an increased density is suggested to be responsible for this increase in real permittivity. The highly nonlinear real and imaginary permittivities of all Fr5 samples measured at 150° C. are large in magnitude. This indicates a lowered impedance. The nonlinear relaxation is assumed due to thermally-activated mobility of ionic groups, probably at the glass fiber-epoxy interphase, as well as contribution from the α-relaxation mode.

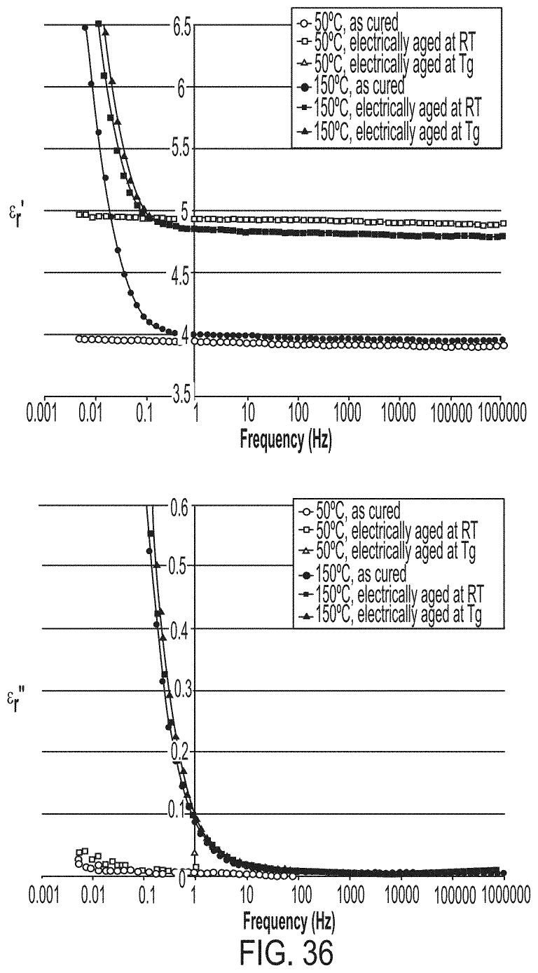

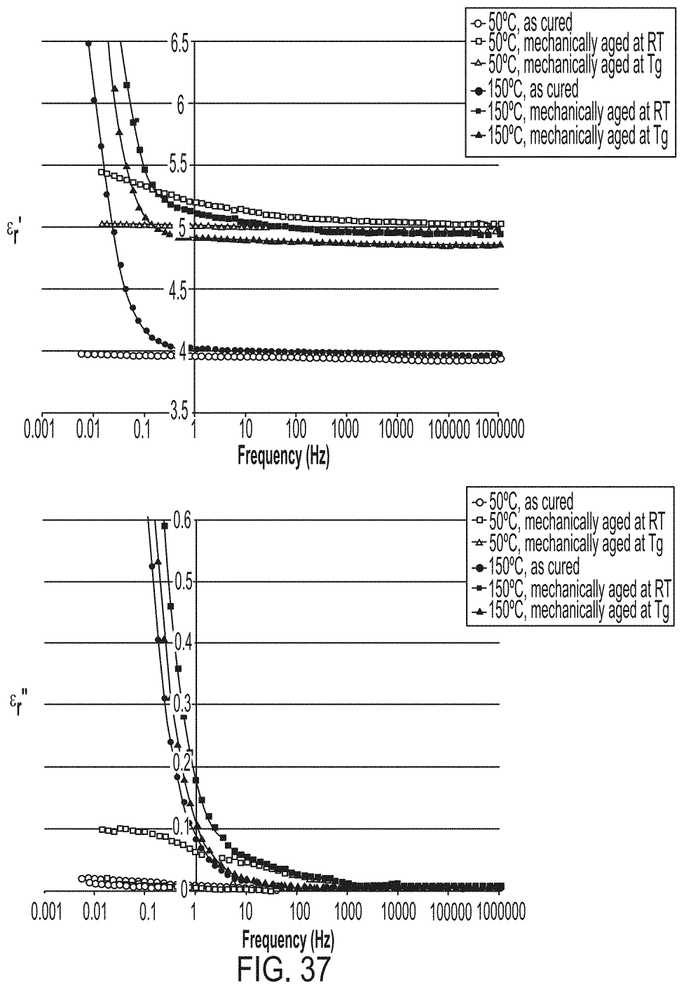

For G7, a pronounced relaxation is again observed at the elevated temperature for all sample conditions. Although similar changes in the spectral form of the real and imaginary permittivities are observed for G7 with temperature, a reduced vertical scale is used in FIGS. 36-37. Another general difference is the absence of a high frequency increase (relaxation) in imaginary permittivity at 50° C. within this spectral range. The real permittivity of G7 increased slightly (2%) across the frequency range at 50° C. after thermal aging. The real permittivity of G7 increased across the frequency range by ˜20% for both electrical aging and mechanical aging as compared with “as cured” condition. For electrical aging, no difference was observed when electrically aged at room temperature or at the glass transition temperature. For mechanical aging, however, the room temperature treatment produced enhanced real and imaginary permittivities at low frequencies, a definite difference in dielectric response. The increase in loss was pronounced at low frequencies at both 50° C. and 150° C. The behavior mirrors the increase in real permittivity under the same conditions.

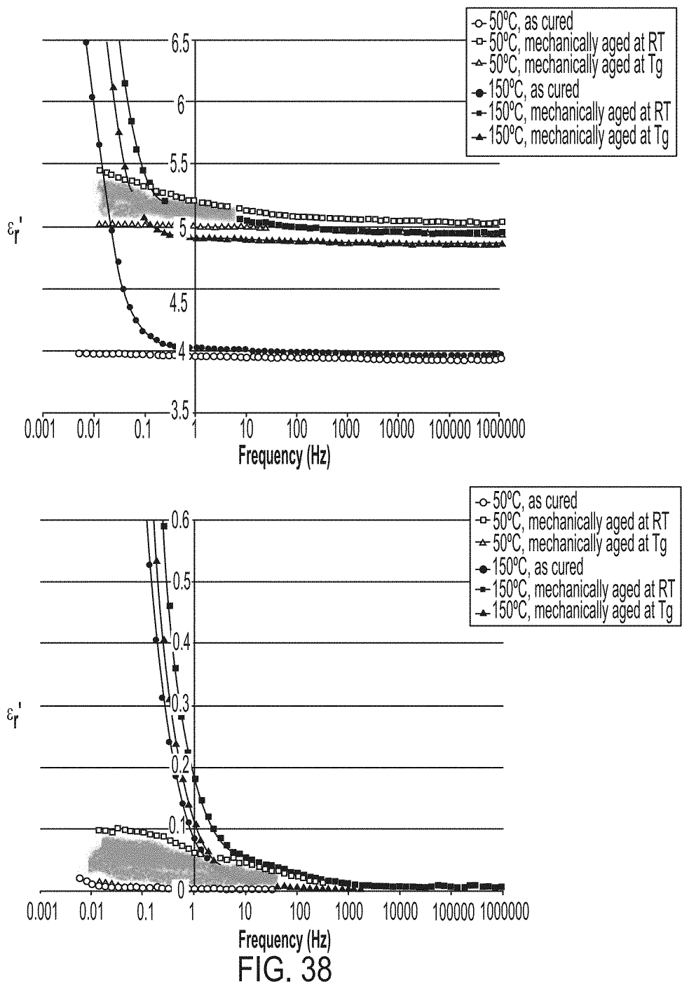

As this behavior is unusual in comparison with the other G7 sample conditions, it is highlighted in FIG. 38 by shading. The available data suggests that mechanical aging of the G7 laminate at room temperature actually caused mechanical damage (de-bonding at the glass fiber-silicone matrix interface). The mechanism for the spectral change would be a MWS mechanism, although appearing at frequencies three orders of magnitude less than anticipated (perhaps due to a dimensional scale).

Comparison with neat resins—The DETA of Fr5 laminate is compared with Pn0 and the DETA of G7 is compared with Sn0. All the data in this section are measured at 30° C. and depicted as electric moduli.

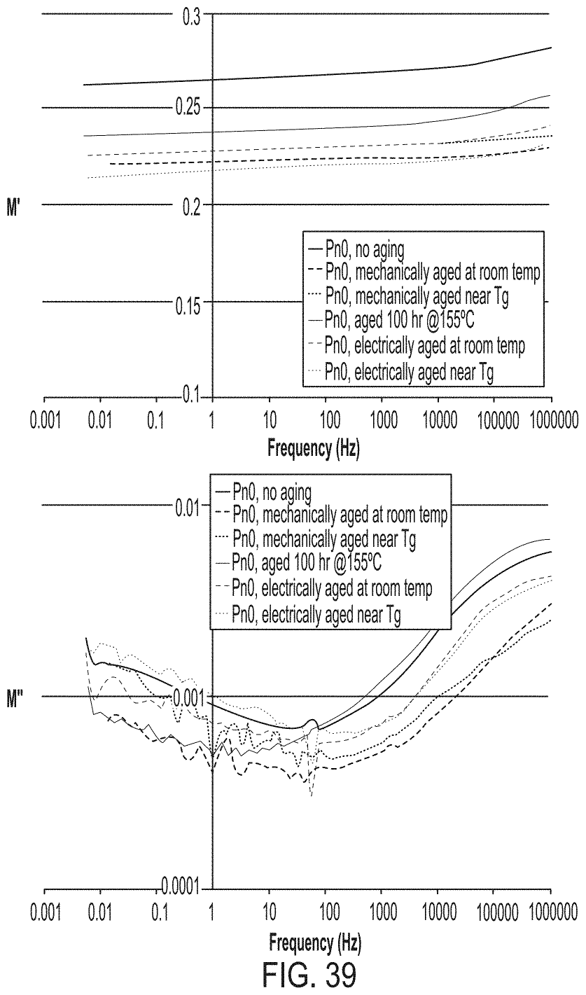

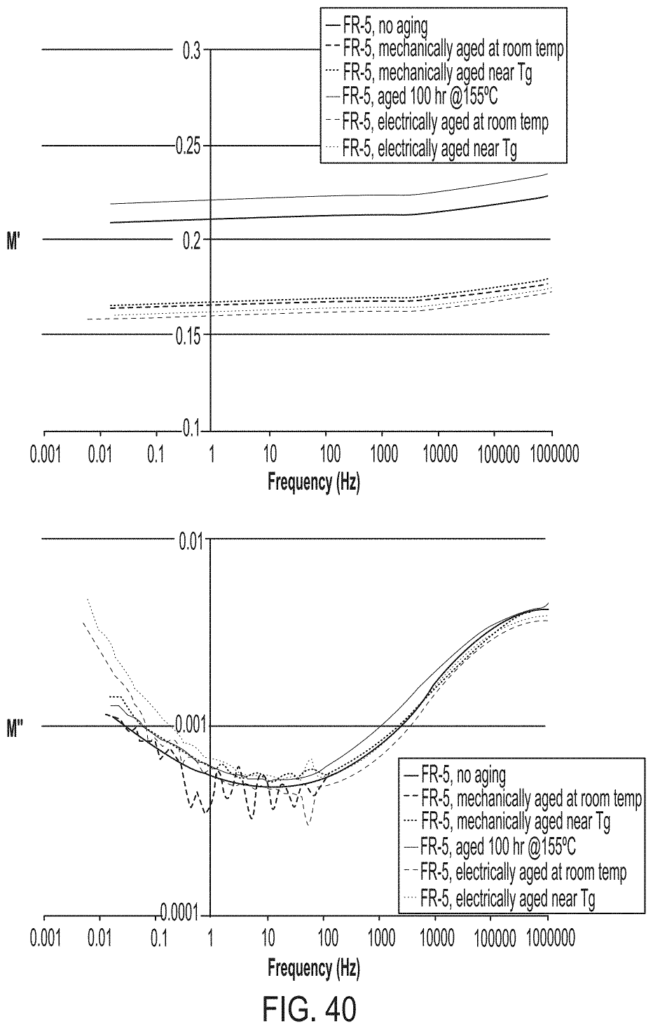

The spectra of electric storage moduli (FIGS. 39-40) indicate that the aging behaviors of the cured epoxy resin, Pn0, and the fiberglass laminate with epoxy matrix, Fr5, are similar near room temperature. The storage moduli are approximately linear with frequency until 10⁴ Hz where the slope increases slightly. The real electric moduli for dynamic field aged Fr5 are less than 80% of the “no aging” or heat-treated laminate. Although the Fr5 real moduli indicate differences with aging treatment, this was not the case with the imaginary moduli. The imaginary loss moduli spectra show the following:
Pn0 at 30° C. is characterized by α-relaxation peaking at <1×10⁻³ Hz and a high intensity B-relaxation peaking at 10⁶-10⁷ Hz. The B-relaxation peak intensity changed with aging treatment. Fr5 is characterized by α-relaxation peaking at ˜1×10⁻³ Hz (higher than pure epoxy) and a high intensity B-relaxation peaking at 10⁶-10⁷ Hz. Only minor differences in B-relaxation peak intensity with aging treatment are observed.
No MWS-relaxation was identified for Fr5 laminate at 30° C., with or without aging treatment.

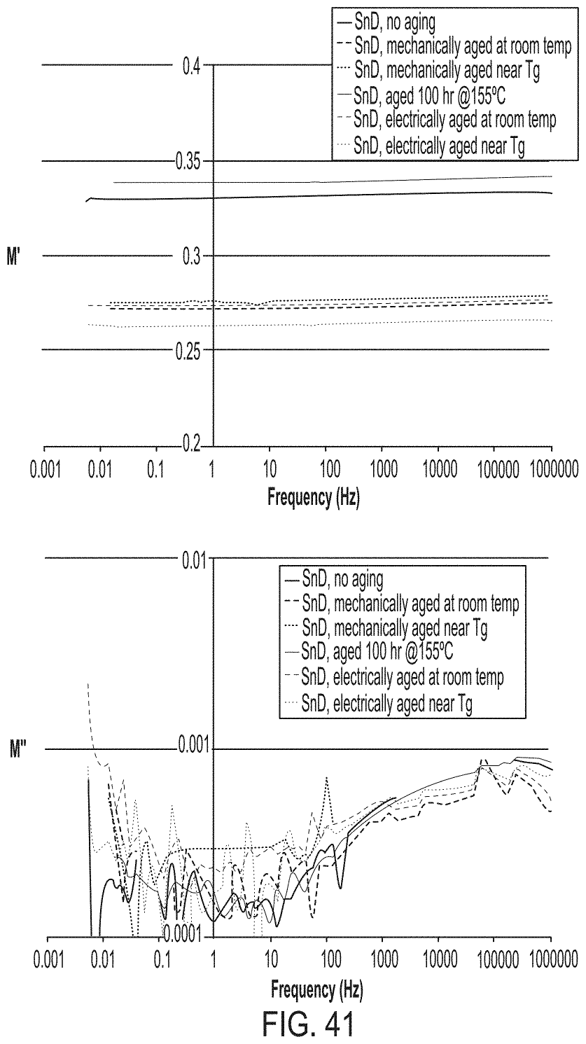

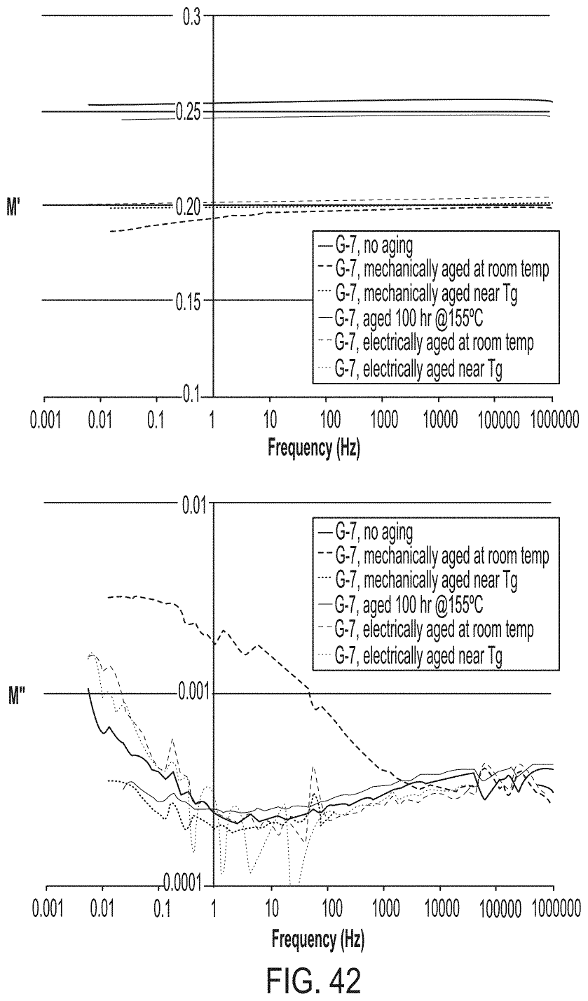

The spectra of real electric moduli in FIGS. 41 and 42 indicate that the aging behaviors of the cured silicone resin, Sn0, and the fiberglass laminate with silicone matrix, G7, are similar. The real electric moduli of the dynamic field aged G7 is ˜80% of the “no aged” or heat-treated laminate. All real electric moduli are linear with frequency and have a very low slope. The exception is G7-MRT (mechanically aged at room temperature) that exhibits a reduced modulus at low frequencies. The imaginary electric loss moduli spectra show the following:
Sn0 at 30° C. is characterized by α-relaxation peaking at ≤1×10⁻³ Hz and a low intensity B-relaxation peaking at ˜10⁷ Hz. G7 is characterized by α-relaxation peaking at <2×10⁻² Hz (higher than neat silicone) and a very low intensity relaxation peaking at ˜10⁷ Hz. This relaxation behavior suggests excellent dielectric response for a highly filled, insulating PMC near room temperature.
Mechanical aging may be an issue. DETA of G7-MRT indicates a broad MWS-relaxation at ˜10¹ Hz, not observed with other aging treatments. The presence of this relaxation is interpreted as due to the initiation of de-adhesion of the fiberglass surfaces to the silicone matrix with the application of 9 kHz vibrations at room temperature. The “relaxation” was not observed with application of 9 kHz at the glass transition temperature. Viscoelastic damping during mechanical aging at the glass transition (-MRT) may have protected against de-adhesion at the fiber surfaces.

DETA of PMC: multilayer epoxy-mica-fiberglass tape—Epoxy-mica-fiberglass tapes are used to wrap form-wound coils prior to resin impregnation. This wrapped layer usually forms the ground-wall insulation and is important in mechanically stiffening the coil. As these tapes consist of a minimum of three material components, the structure and properties can be quite complex. The aging for one tape was assessed to compare with aging of related binary composites. A commercial epoxy-mica-fiberglass tape, Calmicaglas® 4800, was stacked in several layers and cured under pressure. After curing, all samples were heat-treated at 155° C. for 100 hours as a thermal aging treatment. Some samples then received additional aging in dynamic fields at room temperature. The tape layers could be peeled apart, suggesting that the epoxy matrix did not fully fill cavities in and between the layers (no epoxy impregnation step was involved). The related binary composites are epoxy-fiberglass laminate (Fr5) and epoxy-90% mica (ME).

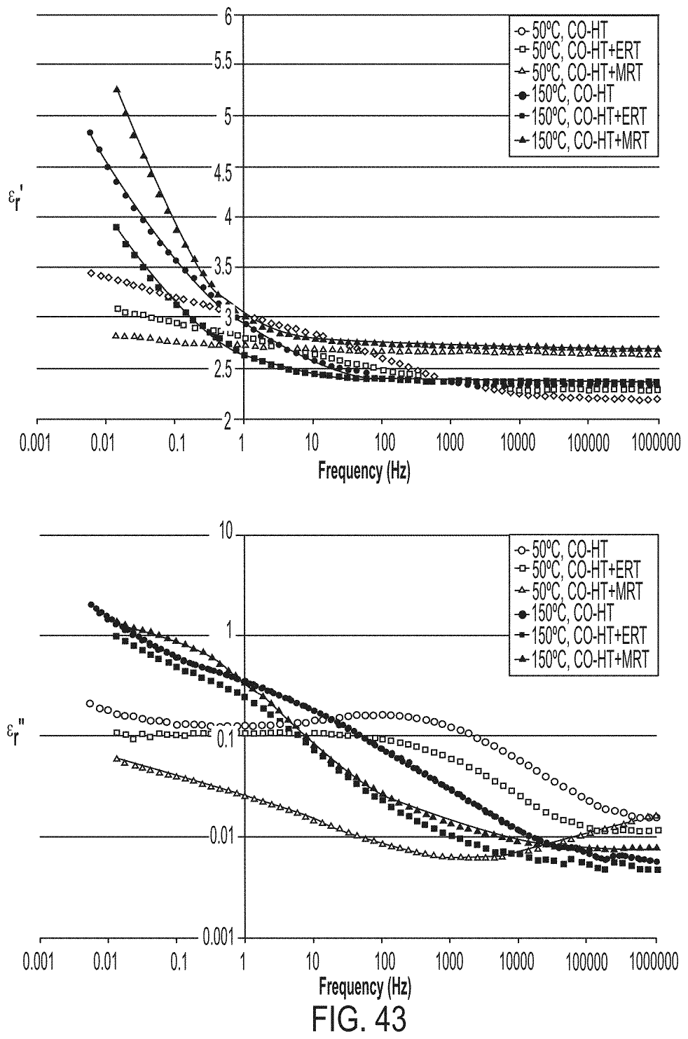

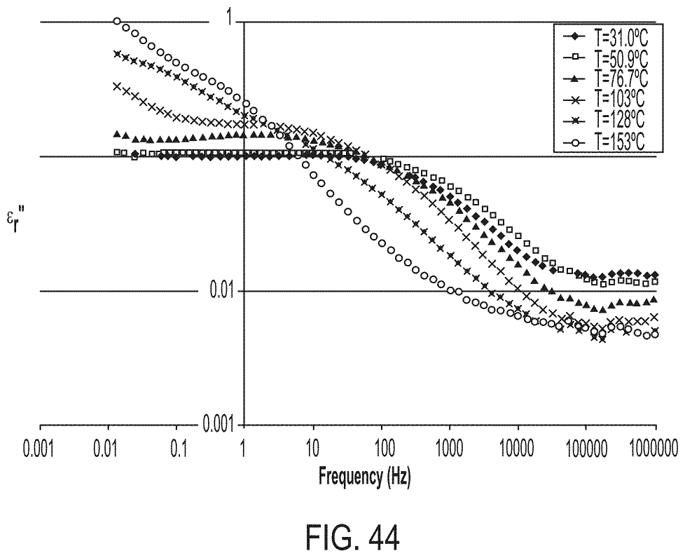

FIG. 43 shows the real permittivity and loss permittivity for the thermally aged tape stack (C0-HT), the stack receiving additional electric aging (C0-HT+ERT), and the stack receiving additional mechanical aging (C0-HT+MRT). The real permittivity was reduced at both 50° C. and 150° C. after dynamic aging treatments. (The exception is a slightly higher permittivity at 50° C. and below 1 Hz.) The imaginary permittivities were similar at 150° C. for all three conditions. At 50° C., however, the loss permittivity of the dynamically aged samples exhibits a very broad relaxation from <1 Hz-10³ Hz. In FIG. 44, this broad loss band is shown to move towards lower frequencies as temperature increases, beginning to overlap with the α-relaxation. This broad loss band was also observed in C0-HT+MRT, but not for the C0-HT sample.

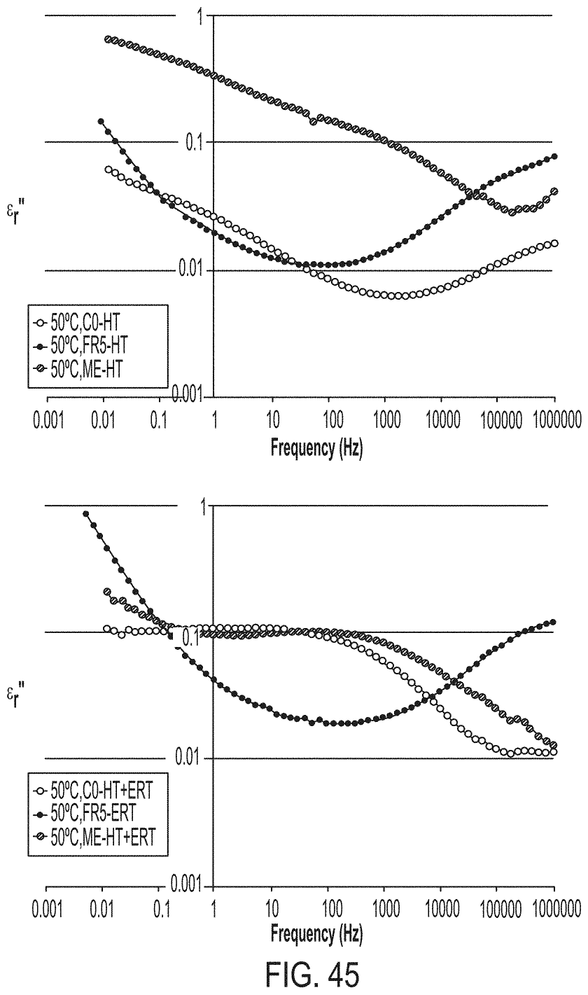

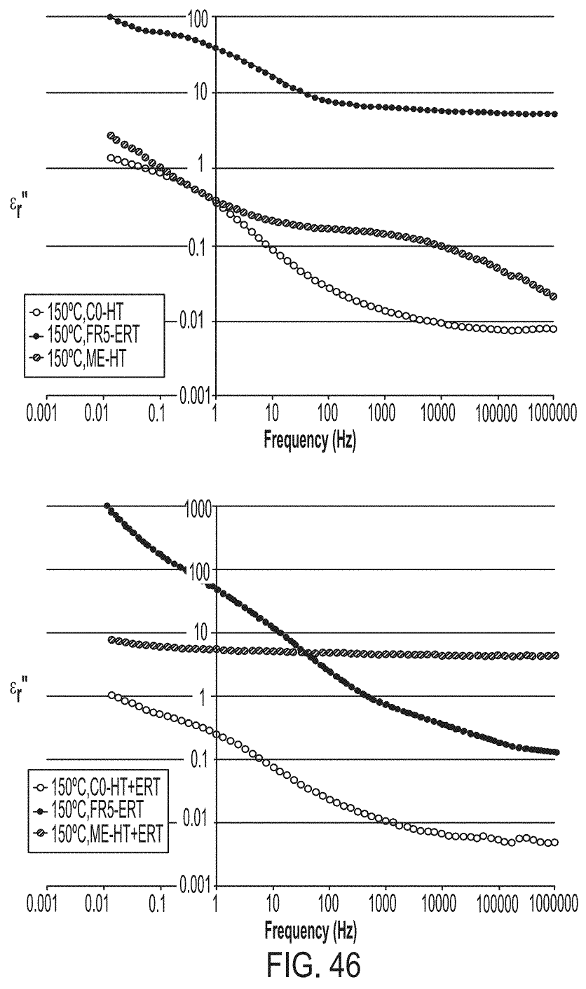

Examining the spectral profiles of the three composites (FIGS. 45 and 46), some interesting observations can be made. At 50° C., the Calmicaglas' loss mimics the behavior of the epoxy-90% mica composite. At 150° C., the Calmicaglas' loss mimics the behavior of the epoxy-fiberglass composite. The dominant loss mechanism in the binary composites appears to dominate in the complex composite, as well. This, of course, is surmised as the compositions and dimensions of the components (e.g., the epoxy, the mica, and the glass) were not the same.

Here again it is shown that thermal aging and dynamic field aging produce different effects in dielectrics, yet insulation often is subjected to the stresses that cause varied aging simultaneously and/or intermittently. The change in aging mechanisms with temperature and with aging treatment precludes the accurate use of kinetic models based solely on a simple Arrhenius relationship. A new approach to kinetic modeling is warranted. Furthermore, accelerated aging regimes based on simple Arrhenius models are unlikely to give accurate predictions of aging lifetimes.

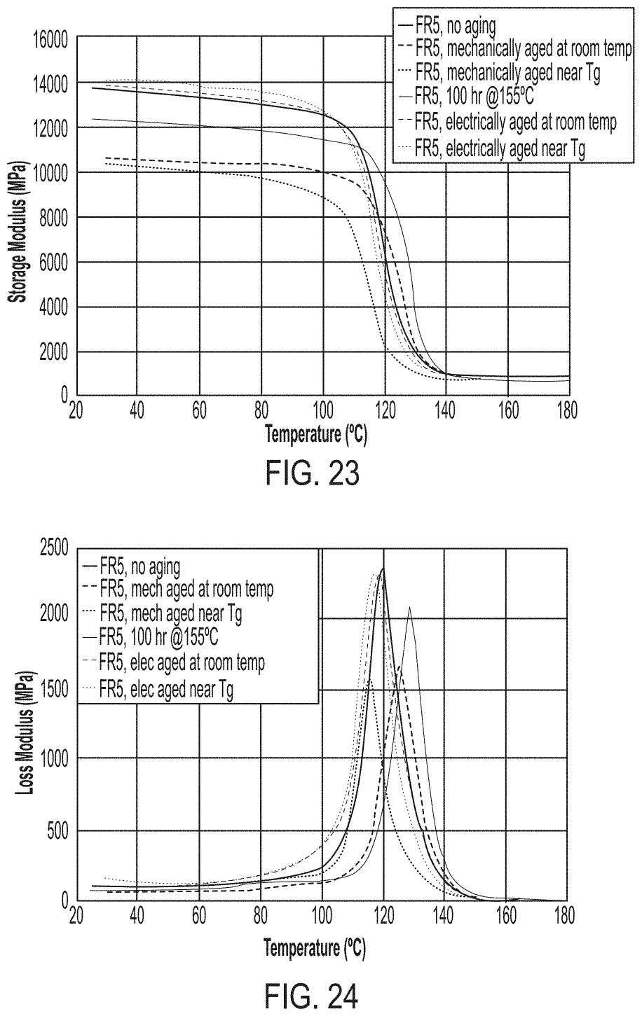

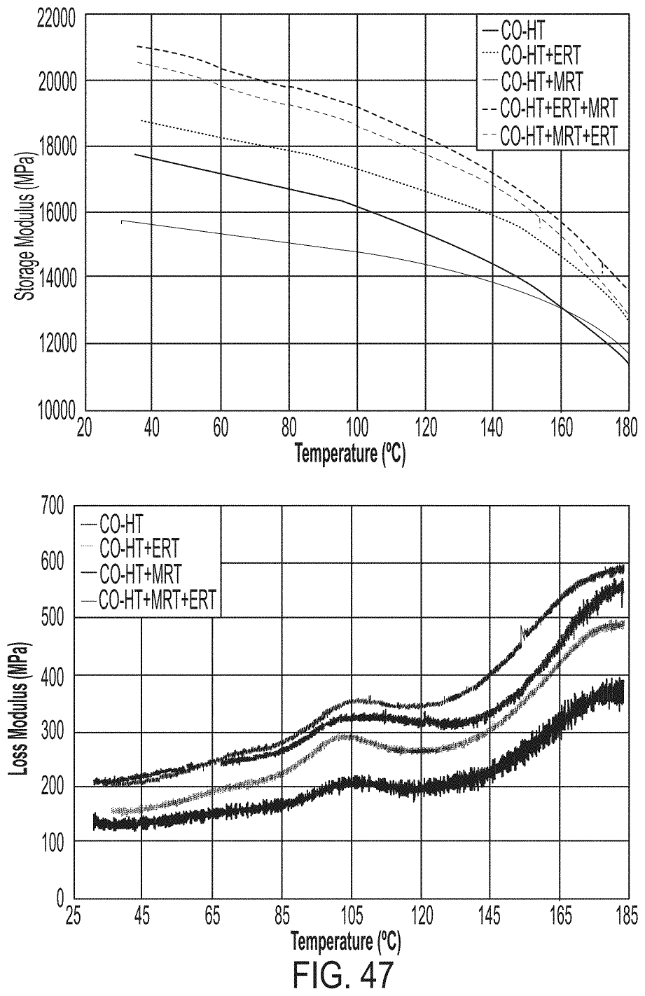

Dynamic extensional moduli characterized with DMA are shown graphically in FIG. 47. The dynamic storage modulus of the layered epoxy-mica-fiberglass sample decreased when dynamic mechanical aging was applied after thermal aging (C0-HT+MRT) and increased with dynamic electrical aging after thermal aging (C0-HT+ERT). Surprisingly, the combination of both electrical aging and mechanical aging after thermal aging further increased the dynamic storage modulus. The dynamic storage moduli at room temperature ranged from 16,000-20,000 MPa (16-20 GPa), above that measured for the epoxy laminate Fr5 (˜14 GPa, FIG. 23). The dynamic loss moduli indicate a glass transition for the epoxy near 100° C. and a glass transition for the fiberglass at ˜185° C. The large spread in the response may be an indication of less than full encapsulation by the epoxy matrix.

Large differences between dynamic elastic moduli of samples with identical treatments were measured. This is thought to be due to the incomplete penetration of the epoxy matrix, probably resulting in a low level of residual porosity.

Activation energies from imaginary electric moduli—Addressing the thermal energy of a mode is important information. Where N is Avogadro's number, an Arrhenius form of equation typically used is:

$${f}_{p k} = {f}_{0} exp \frac{- E}{NkT}$$

Data are fit to this equation to extract a characteristic activation energy, E. Another option is based on the Eyring equation, best suited for phase transitions:

$${f}_{p k} / T = {f}_{e} exp \frac{- {E}_{e}}{NkT}$$

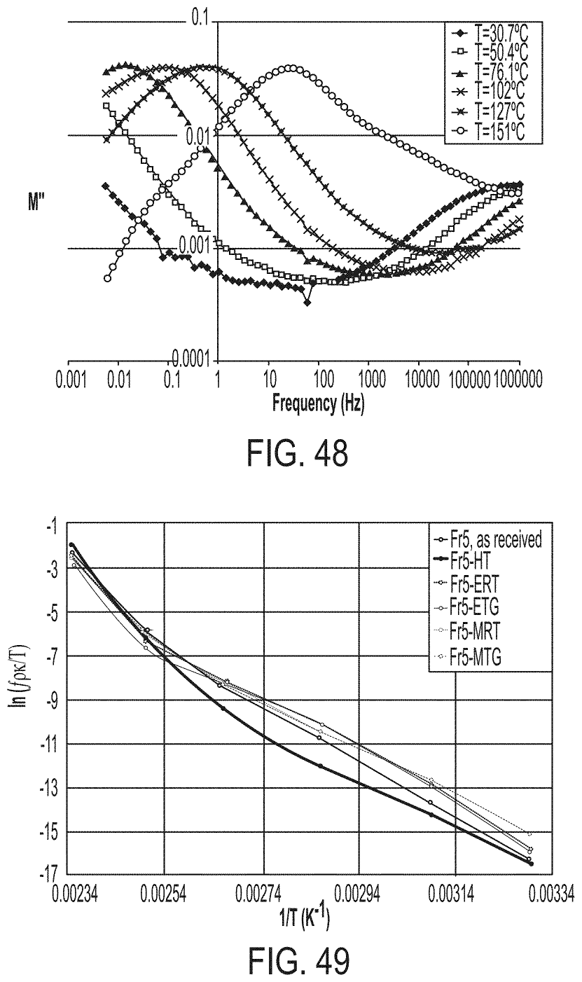

The following compares the derived activation energies for various material conditions. FIG. 48 shows an example of the α-relaxation mode peaking at frequencies below 10³ Hz at six temperatures for Fr5-ERT, an electrically aged, fiberglass-epoxy laminate. The peak or apex of the relaxation increases in frequency (increases energy) as the temperature is raised. A plot of the ln(fₚₖ/T) as a function of reciprocal temperature is shown in FIG. 49, following the Eyring equation.

Linear fits to this data were made at the two highest temperatures (both above the glass transition temperature for each material) and for three temperatures below the glass transition temperature. Both activation energies for the α-relaxation for six Fr5 conditions are listed in Table 5. (As the peak frequency of the α-relaxation at the highest reciprocal temperature (lowest temperature) was extrapolated with high uncertainty, this data point was not included.) The low temperature activation energy was approximately half of the activation energy above the glass transition temperature. The activation energies of the aged laminates decreased at temperatures below the glass transition temperatures. At temperatures above the glass transition temperatures, the activation energies were higher than for the as received material. This indicates that the aging treatments improved the ability of the polymer network to perform coordinated molecular motion in response to electric fields.

TABLE 5
Activation energies for the a-relaxation of Fr5 for each aging condition

| | Activation | Activation |
|---|---|---|
| | Energy at | Energy at |
| Condition | T > Tg (J/mol) | T < Tg (J/mol) |
| Fr5 (as received) | 1.90E+05 | 1.04E+05 |
| Fr5-HT (heat-treated) | 2.32E+05 | 0.94E+05 |
| Fr5-ERT (electrically aged at RT) | 2.09E+05 | 0.93E+05 |
| Fr5-ETG (electrically aged at Tg) | 2.14E+05 | 0.92E+05 |
| Fr5-MRT (mechanically aged at RT) | 1.93E+05 | 0.87E+05 |
| Fr5-MTG (mechanically aged at Tg) | 1.91E+05 | 0.84E+05 |

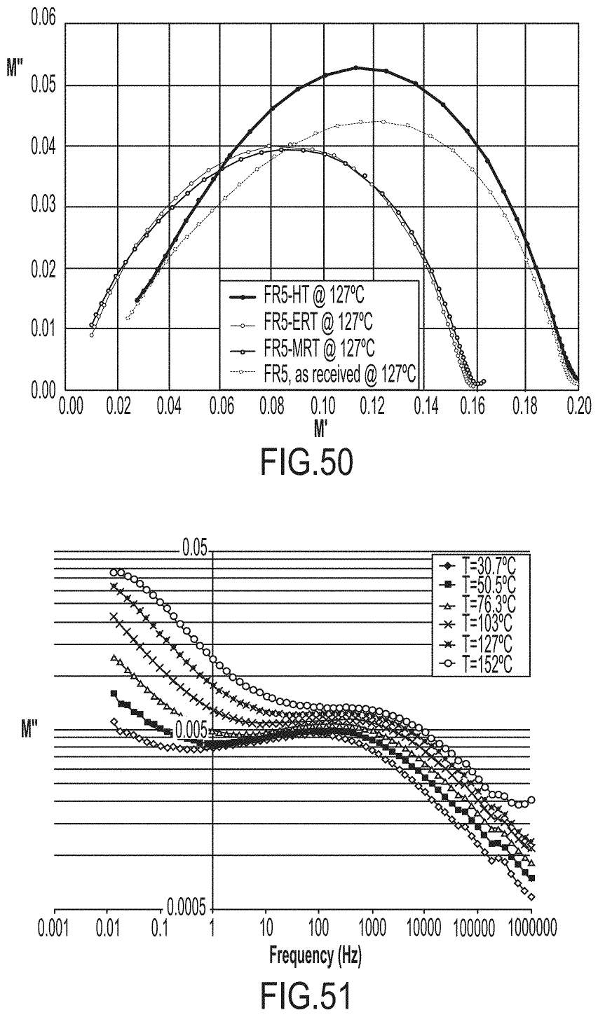

At 127° C., close to glass transition temperature for four aging conditions of FR5, the full α-relaxation is recorded within the available spectral range. FIG. 50 shows a Cole-Cole plot of the complex electric moduli. This plot most clearly indicates differences in dielectric response after aging.

The MWS-relaxation is not expected to exhibit thermal dependence (Huang et al., Understanding the strain-dependent dielectric behavior of carbon black reinforced natural rubber-an interfacial or bulk phenomenon? Comp. Sci. Tech., 142 (2016): 91-97). The frequency of maximum imaginary loss modulus for this relaxation appears to be somewhat constant for a composite material. The breath and dielectric strength of the MWS-relaxation does appear to be related to the temperature and amount of second phase. In the case of phase separation, where the local composition can change with temperature as the separation evolves, the MWS-relaxation appears to shift in frequency with the changing temperature.

All nano-silica modified and mica-filled PMC exhibited possible MWS-relaxation behavior at high temperature. At low temperature, the relaxation was not observed. The 90 wt. % mica-epoxy composite, ME-HT+ERT, exhibited a uniform progression of the MWS-relaxation mode through the temperature range explored. This commercial PMC had been subjected to heat-treatment followed by electrical aging at room temperature. The MWS-relaxation can be observed as a broad band in the imaginary electric modulus around 10³ Hz (FIG. 51). A slight progression to higher frequency as temperature increased followed an Arrhenius-type behavior with a low activation energy of 1.2E+04 J/mol. There is a possibility that this shift results from thermal expansion and frequency shifts of the α-relaxation and B-relaxation with temperature. Without significant curve-fitting, weak Arrhenius behavior can only be suggested.

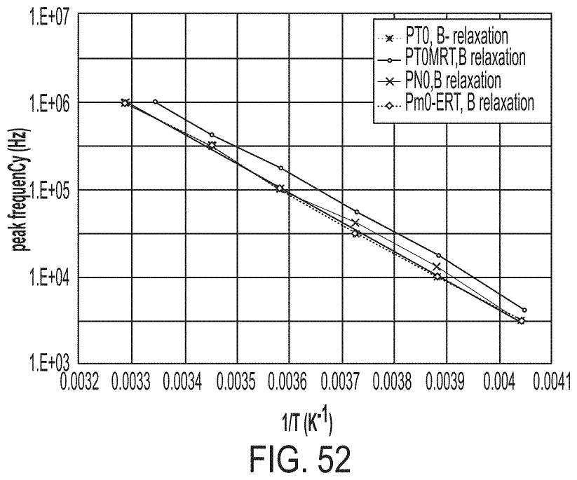

DETA spectra were measured for four epoxy PMC at temperatures below room temperature. The peak frequency values are considered reliable as the maxima were observed within the spectral range (extrapolations were unnecessary). To access the B-relaxation activation energies, the peak frequencies are plotted vs. the reciprocal temperature as in FIG. 52. The B-relaxation mode follows Arrhenius behavior. Table 6 lists the derived activation energies. Aging treatment and particulate addition appear to have essentially no effect on the activation energies for the B-relaxation mode.

TABLE 6
Activation energies for the α-relaxation of 'filled epoxy for each condition

| | | Activation |
|---|---|---|
| Condition | Fit to M″ spectra | Energy (J/mol) |
| PnO (neat, no aging) | fₚₖ = 1.26E+17e^{-7.77E+03/T} | 6.5E+04 |
| PtO (nano-silica modified, no | fₚₖ = 1.26E+17e^{-7.77E+03/T} | 6.5E+04 |
| aging) | | |
| PtO-MRT (nano-silica modified, | fₚₖ = 1.26E+17e^{-7.77E+03/T} | 6.4E+04 |
| mechanically aged at RT) | | |
| PmO-ERT (mica-filled, | fₚₖ = 1.26E+17e^{-7.77E+03/T} | 6.5E+04 |
| electrically aged at RT) | | |

The dielectric strength of the B-relaxation (i.e., mode intensity) is known to be dependent on the nature of the dipole moments exhibited by ligands attached to the main network structure (e.g., “chain” or “backbone”) (Kalogeras, Contributions of dielectric analysis in the study of nanoscale properties and phenomena in polymers. Prog. Polym. Nanocomp. Res., Chpt. 10, eds. S. Thomas and G. E. Zaikov, (2008): ISBN:978-1-60456-484-6). Higher rigidity side groups generate weak B-relaxations as observed for the silicone thermoset, Sn0. More flexible and polarizable side groups generate strong B-relaxations as observed for epoxy, Pn0. For these thermoset polymers, the B-relaxation is observed around 1 MHz, close to the frequency target of new high switching speed PEBBs and within the third harmonic range of lower switching PEBBs.

In summary, the above PMC with an epoxy matrix demonstrated average activation energies of 6.5E+04 J/mol for a B-relaxation and 1.2E+04 J/mol for a MWS-relaxation in epoxy-fiberglass laminate. The 6.5E+04 J/mol for the B-relaxation found here is close to the 6.7E+04 J/mol (0.69 eV) published for a cured neat epoxy (Fuse et al., Evaluation of dielectric properties in polypropylene/clay nanocomposites. IEEE Conf. Elect. Insul. Diel. Phenomena (2009): 507-510). The α-relaxation was found to vary with aging treatment and did not follow a traditional Arrhenius behavior. However, estimates of two activation energies were made: one above the glass transition temperature and one below the glass transition temperature. The lower temperature activation energy (˜1E+05 J/mol) was about half that of the high temperature activation energy (˜2E+05 J/mol). Of the three modes, the coordinated primary α-relaxation has the highest activation energy. A Cole-Cole plot of the electric modulus was the clearest indicator of aging differences.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A method comprising:
providing a polymeric material; and
inducing optical or acoustic phonons into the material;
wherein the inducing is performed by application of an alternating electric field or a dynamic mechanical field.

2. The method of claim 1, wherein the electric field has a frequency of 50 to 500,000 Hz.

3. The method of claim 2, wherein the frequency of the electric field is varied over time.

4. The method of claim 1, wherein the electric field has a field strength of 0.1 to 1 MV/m.

5. The method of claim 1, wherein dynamic mechanical field is ultrasonic waves having a frequency of 4000 Hz to 45,000 Hz.

6. The method of claim 5, wherein the frequency of the ultrasonic waves is varied over time.

7. The method of claim 1, wherein phonons have a frequency of 1 Hz to 1 GHz.

8. The method of claim 1, wherein the inducing continues for at least 1 hour.

9. The method of claim 1, wherein the method produces nano-phase separation in the polymer.

10. The method of claim 1, wherein the method increases the density of the polymer.

11. The method of claim 1, wherein the method increases the voltage breakdown strength of the polymer.

12. A composition comprising a polyepoxy thermoset, wherein the composition has a water absorption rate of no more than 0.1 wt. % per 24 hours.
